(19) United States
(12) Patent Application Publication
(10) Pub. No.: US 2013/0041780 A1
(43) Pub. Date: Feb. 14, 2013

(54) NAIL DESIGN DISPLAY CONTROL APPARATUS AND DISPLAY CONTROL METHOD

(71) Applicant: Hiroyasu BITOH, Tokyo (JP)

(72) Inventor: Hiroyasu BITOH, Tokyo (JP)

(73) Assignee: CASIO COMPUTER CO., LTD., Tokyo (JP)

(21) Appl. No.: 13/568,461

(22) Filed: Aug. 7, 2012

(30) Foreign Application Priority Data
Aug. 10, 2011 (JP) 2011-174465

(51) Int. Cl. G06Q 30/06

(52) U.S. Cl. 705/27.1

(57) ABSTRACT

A nail design display control apparatus including a first storage circuit which stores a plurality of nail designs, each of which being associated with evaluation values indicating matching levels of a nail design with respect a plurality of related items, an item specifying unit by which a user specifies one or more of related items among a plurality of related items; and an evaluation calculation unit which calculates a sum of the evaluation values with respect to the related items specified by the user for each of the plurality of nail designs.

### CROSS-REFERENCE TO RELATED APPLICATIONS

This application is based upon and claims the benefit of priority under 35 USC 119 of Japanese Patent Application No. 2011-174465 filed on Aug. 10, 2011, the entire disclosure of which, including the description, claims, drawings, and abstract, is incorporated herein by reference in its entirety.

### BACKGROUND OF THE INVENTION

1. Field of the Invention

The present invention relates to a nail design display control apparatus and a display control method.

2. Description of the Related Art

In JP 2003-534083, there is suggested a nail print apparatus in which fingers including nail portions on which printing is to be performed are positioned on a finger placement table provided in the apparatus main body and a nail design consists of various colors, designs and the like is to be printed on the nail portions of the positioned fingers.

Further, there is suggested an apparatus which performs printing of nail design on stickers which are to be adhered on nail portions and not directly on nail portions. By using stickers on which nail design is printed by such apparatus, anyone can easily enjoy applying nail arts.

In such apparatus, for example, a plurality of nail designs are displayed in a display screen so that the nail design which a user desires to print can be selected in the display screen and the desired nail design can be printed.

Nail manicure is a part of fashion and has an important role in coordination with outfits and others. However, it is difficult to determine which nail design fits her outfit among a plurality of nail designs and to appropriately choose the nail design which is a good match with her outfit. Therefore, there are cases where the nail design printed on the nail portion does not match the outfit of the day.

In response to such problem, recently, there are nail salons having “nail concierge” who helps to select the best suited nail design and makes suggestions as a counseling staff who can give professional advices by broadly taking situations such as taste of clothing of the customer, season, places to go and the like into consideration in addition to the “manicure artist” who applies nail design on nail portions of the customer.

In such nail salon having a “nail concierge”, even though the customer does not have a great knowledge of nail art, the customer can receive advise as to which nail design suits her request just by telling the “nail concierge” the outfit she plans to wear and the situation of the occasion where she plans to go with her nails done. Therefore, the customer can choose the nail design without failure.

However, when using a nail print apparatus or the like which performs printing of nail design at home or the like, a user cannot talk to a professional staff such as the nail concierge.

Therefore, there is a problem that a user may select a nail design which does not match her outfit not being able to select the suited nail design even when variation of nail design that can be printed is increased in the nail print apparatus. Further, there may be a problem that a user always chooses the same nail design and not able to enjoy great variation of nail design for different occasions.

### SUMMARY OF THE INVENTION

In view of the above problems, an object of the present invention is to provide a nail design display control apparatus and a display control method which can accurately and quickly suggest a nail design which suits the outfit or the like for an occasion just by carrying our a simple operation.

According to one aspect of the present invention, there is provided a nail design display control apparatus including a first storage circuit which stores a plurality of nail designs, each of which being associated with evaluation values indicating matching levels of a nail design with respect a plurality of related items, an item specifying unit by which a user specifies one or more of related items among a plurality of related items and an evaluation calculation unit which calculates a sum of the evaluation values with respect to the related items specified by the user for each of the plurality of nail designs.

According to another aspect of the present invention, there is provided a display control method for a nail design display, wherein a first storage circuit stores a plurality of nail designs, each of which being associated with evaluation values indicating matching levels of a nail design with respect to a plurality of related items, and wherein the display control method includes calculating a sum of the evaluation values of the related items specified by a user for each of the plurality of nail designs when one or a plurality of related item is specified by the user among the plurality of related items.

### BRIEF DESCRIPTION OF THE DRAWINGS

The above and other objects, advantages and features of the present invention will become more fully understood from the detailed description given hereinbelow and the appended drawings which are given by way of illustration only, and thus are not intended as a definition of the limits of the present invention, and wherein:

FIG. 1 is a schematic view which conceptually shows a embodiment of a nail print apparatus according to the present invention, a state where the cover is opened is being shown;

FIG. 2 is a schematic view which conceptually shows an apparatus main body of the nail print apparatus of FIG. 1;

FIG. 3 is a cross-sectional view showing a printing finger fixing unit which is a major part of the nail print apparatus of FIG. 1, a fixed condition where the index finger to little finger are inserted in a printing finger inserting unit as printing fingers being shown;

FIG. 4 is a cross-sectional diagram of the front side of the nail print apparatus of FIG. 1;

FIG. 5 is a sectional side view of the nail print apparatus of FIG. 1;

FIG. 6 is a block diagram of major parts showing a control configuration of the nail print apparatus according to the embodiment;

FIG. 7 is a diagram showing a configuration example of evaluation data unit for nail concierge in ROM of FIG. 6;

FIG. 8 is a diagram showing a configuration example of evaluation result data unit for nail concierge in RAM of FIG. 6;

FIG. 9 is a flowchart showing an overall flow of nail design selection processing performed in the embodiment;

FIG. 10 is a flowchart showing nail design display processing of nail catalog mode performed in the embodiment;

FIG. 11 is a flowchart showing nail design display processing of nail catalog mode performed in the embodiment;

FIG. 12 is a flowchart showing nail design display processing of nail concierge mode performed in the embodiment;

FIG. 13 is a flowchart showing nail design display processing of nail concierge mode performed in the embodiment;

FIG. 14 is a flowchart showing nail design display processing of nail concierge mode performed in the embodiment;

FIG. 15 is a flowchart showing evaluation calculation processing in the nail design display processing of nail concierge mode;

FIG. 16 is a diagram showing an example of mode selection screen in the embodiment;

FIG. 17 is a diagram showing an example of search setting screen in nail catalog mode;

FIG. 18 is a diagram showing an example of search result screen in nail catalog mode;

FIG. 19 is a diagram showing an example of design selection screen in nail catalog mode;

FIG. 20 is a diagram showing an example of design confirmation screen in nail catalog mode;

FIG. 21 is a diagram showing an example of a first item setting screen in nail concierge mode;

FIG. 22 is a diagram showing an example of a second item setting screen in nail concierge mode;

FIG. 23 is a diagram showing an example of a third item setting screen in nail concierge mode;

FIG. 24 is a diagram showing an example of a fourth item setting screen in nail concierge mode;

FIG. 25 is a diagram showing an example of a fifth item setting screen in nail concierge mode;

FIG. 26 is a diagram showing an example of a sixth item setting screen in nail concierge mode;

FIG. 27 is a diagram showing an example of a seventh item setting screen in nail concierge mode;

FIG. 28 is a diagram showing an example of item setting result of the embodiment;

FIG. 29 is a diagram showing an example of evaluation result screen in nail concierge mode;

FIG. 30 is a diagram showing an example of evaluation result screen in nail concierge mode;

FIG. 31 is a diagram showing an example of design selection screen in nail concierge mode; and

FIG. 32 is a diagram showing an example of design confirmation screen in nail concierge mode.

### DESCRIPTION OF THE PREFERRED EMBODIMENTS

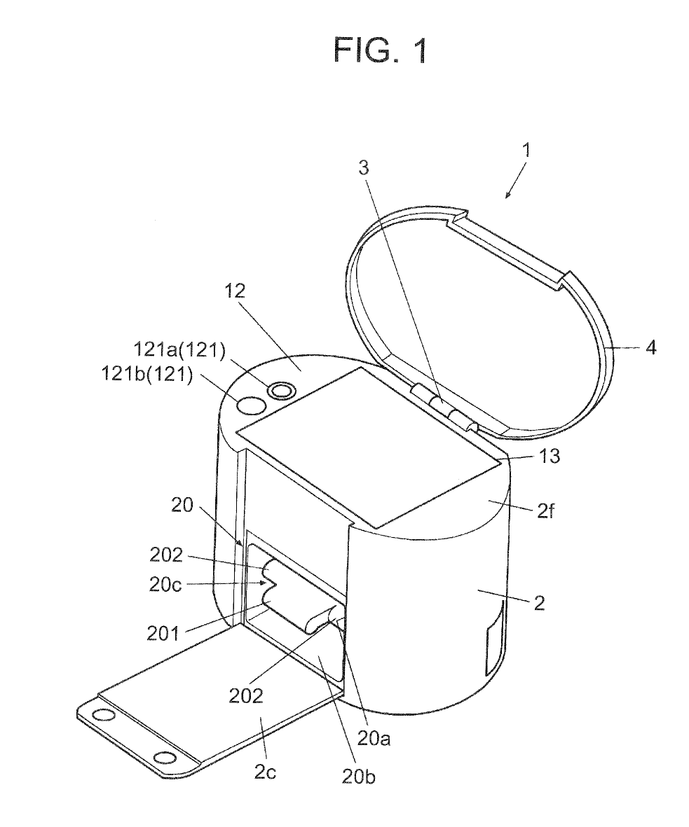

An embodiment of a nail design display control apparatus according to the present invention will be described with reference to FIGS. 1 to 32. In this embodiment, descriptions will be given by taking a case of nail print apparatus in which a nail design display control apparatus includes a print unit and the like and the selected nail design is to be printed on nail portions of a user as an example. However, nail design display control apparatus to which the present invention can be applied is not limited to such nail print apparatuses.

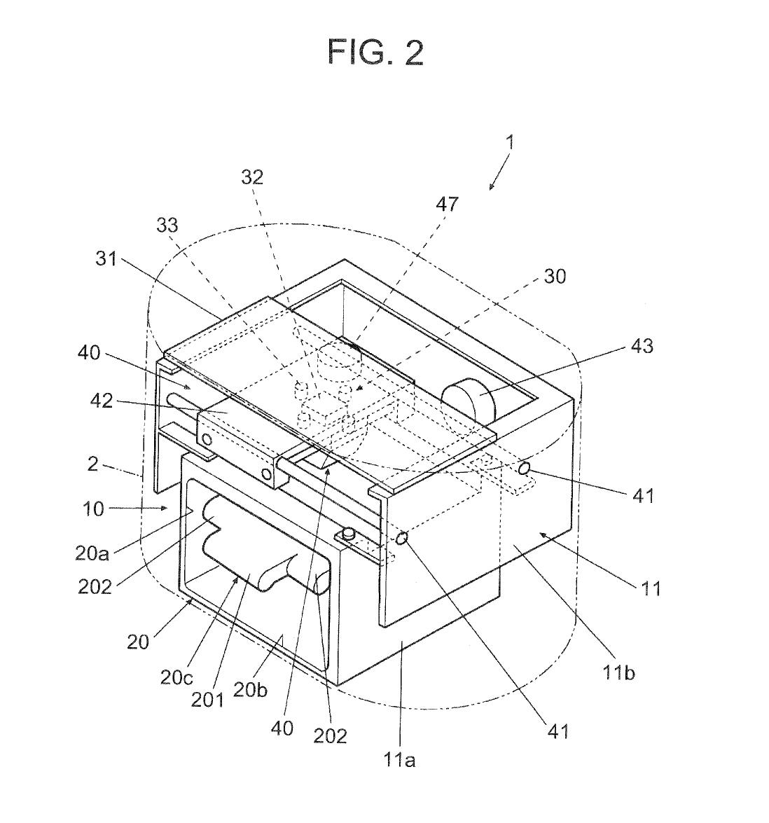

FIG. 1 is a schematic view showing an outer appearance of a nail print apparatus of the embodiment, and FIG. 2 is a schematic diagram showing an inner configuration of the nail print apparatus.

As shown in FIG. 1, the nail print apparatus 1 includes a case main body 2 and a cover 4. The case main body 2 and the cover 4 are joined to each other via a hinge 3 provided at the back edge section of the upper surface of the case main body 2.

The case main body 2 is formed in an oblong circular shape seen planarly. An open-close plate 2c is provided at the front side of the case main body 2 so as to rise and fall. The open-close plate 2c is joined to the case main body 2 via a hinge (not shown in the drawing) provided at the lower edge section of the front surface of the case main body 2. The open-close plate 2c is for opening and closing the front side of the case main body 2.

Further, the after-mentioned operation unit 12 and display unit 13 are disposed on the top board 2f of the case main body 2.

Here, shapes and configurations of the case main body 2 and the cover 4 are not limited to the above exemplified shapes and configurations.

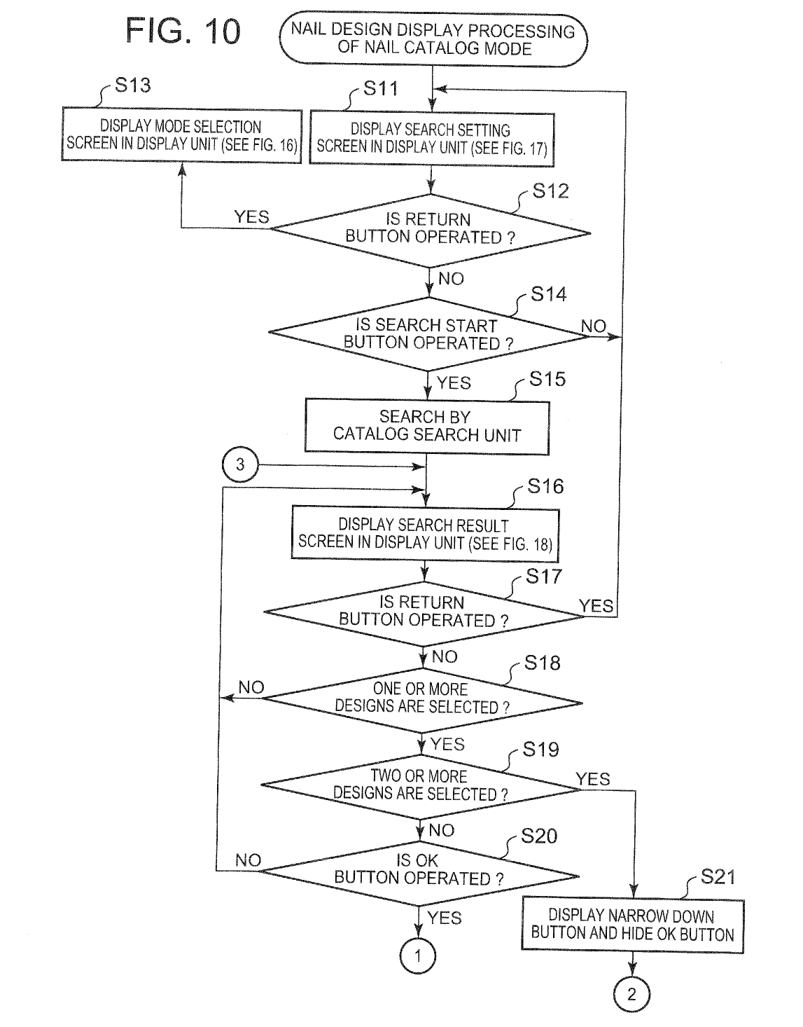

The apparatus main body 10 of the nail print apparatus 1 is housed in the case main body 2. The apparatus main body 10 includes a printing finger fixing unit 20 which constitutes the printing finger fixing unit showing in FIG. 2, a photographing unit 30, a print unit 40 and a control device 50 (see FIG. 10). These printing finger fixing unit 20, the photographing unit 30, the print unit 40 and the control device 50 are provided inside the machine casing 11.

Here, the machine casing 11 is constituted of a lower machine casing 11a and an upper machine casing 11b. The lower machine casing 11a is formed in a box shape and is disposed at a lower part inside the case main body 2, and the upper machine casing 11b is disposed above the lower machine casing 11a at an upper part inside the case main body 2.

The printing finger fixing unit 20 is provided in the lower machine casing 11a which is inside machine casing 11. The printing finger fixing unit 20 is configured by including the printing finger insertion unit 20a, the non-printing finger insertion unit 20b and the holding unit 20c which are provided in the lower machine casing 11a.

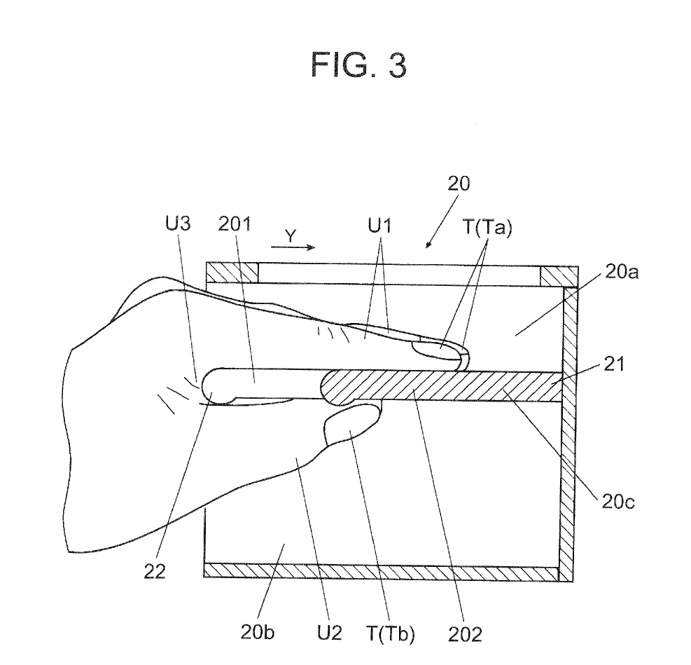

Here, the printing finger insertion unit 20a is a finger insertion unit for inserting fingers U1 (hereinafter, called “printing fingers”) corresponding to the nail portions T on which printing is to be performed (see FIG. 3).

The non-printing finger insertion unit 20b is a finger insertion unit for inserting a finger U2 (hereinafter, called “non-printing finger”) which is other than the printing fingers (see FIG. 3).

The holding unit 20c is a portion which can be sandwiched between the printing fingers U1 inserted in the printing finger insertion unit 20a and the non-printing finger U2 inserted in the non-printing finger insertion unit 20b. In the embodiment, the holding unit 20c is configured of the partition 21 which separates the printing finger insertion unit 20a from the non-printing finger insertion unit 20b.

The upper surface of the holding unit 20c constitutes the flat printing finger placement surface. A bulged portion 22 is formed at the edge section of finger insertion side of the holding unit 200c. The bulged portion 22 is formed at the part where the bases U3 of the printing fingers U1 and the non-printing finger U2 abut when the printing fingers U1 and the non-printing finger U2 are inserted deeply in the printing finger insertion unit 20a and the non-printing finger insertion unit 20b, respectively. The cross sectional shape of the bulged portion 22 is a circular shape that bulges downward from the lower surface of the holding unit 20c so that the holding unit 20c can be sandwiched firmly between the printing fingers U1 and the non-printing finger U2 in a state where all of the balls of the printing fingers U1 contact the printing finger placement surface. Here, the shape of the bulged portion 22 is not limited to the circular shape in section, and the shape can be an oval shape in section, a non-circular shape such as a polygonal shape or the like.

FIG. 3 is a diagram specifically showing an example when the printing fingers U1 are fixed in a case where the four fingers (index finger, middle finger, ring finger and little finger) other than the thumb of the left hand are printing fingers U1.

In such case, the printing fingers U1 are fixated on the holding unit 20c by a user sandwiching the holding unit 20c between the printing fingers U1 inserted in the printing finger insertion unit 20a and the non-printing finger U2 inserted in the non-printing finger insertion unit 20b as shown in FIG. 3.

As shown in FIGS. 1 to 3, in the embodiment, a first finger positioning unit 201 which can decide the positions of the four fingers, which are the index finger to the little finger, by the bases U3 of the printing fingers U1 inserted in the printing finger insertion unit 20a, which are four fingers from the index finger to little finger, and the non-printing finger U2 inserted in the non-printing finger insertion unit 20b, which is the other finger (that is, the thumb), abutting against the end section thereof is disposed at the center of the holding unit 20c in its width direction.

In the embodiment, the length size in width direction X of the first finger positioning unit 201 is approximately the same as or slightly larger than the width size of the four fingers, from the index finger to little finger, inserted in the printing finger insertion unit 20a in right-left direction.

Further, the holding unit 20c includes second finger positioning units 202 disposed respectively in the left and right sides of the first finger positioning unit 201, each of the second finger positioning units 202 allowing to decide the position of the thumb inserted in the printing finger insertion unit 20a by the bases U3 of the thumb which is the printing finger U1 inserted in the printing finger insertion unit 20a and the other fingers (that are, four fingers from the index finger to little finger) which are the non-printing fingers U2 inserted in the non-printing finger insertion unit 20b abutting against the edge section of the second finger positioning unit 202.

The second finger positioning units 202 are disposed so that the edge sections thereof are shifted more in the back in the insertion direction Y of the printing fingers comparing to the edge section of the first finger positioning unit 201. How much the edge sections of the second finger positioning units 202 are to be shifted in relation to the edge section of the first finger positioning unit 201 is not specifically limited. However, it is preferred that the edge sections of the second finger positioning units 202 are shifted to an extent that the nail portion Tb of the thumb and the nail portions Ta of the other four fingers align horizontally.

Although the thumb is short comparing to the other four fingers in a human hand, and there are many ways of holding and sandwiching and individual differences, there is a length difference of 40 to 75 mm between the thumb and the other four fingers. In consideration of such length difference in the fingers, the edge sections of the second finger positioning units 202 are preferably shifted more in the back in the insertion direction Y of the printing finger U1 for about 40 to 75 mm than the edge section of the first finger positioning unit 201.

When the edge sections of the second finger positioning units 202 which decides the position of the thumb are shifted more in the back in the insertion direction Y of the printing finger than the edge section of the first finger positioning unit 201 for about 40 to 75 mm as in the embodiment, because the positions of the nail portion Tb of the thumb and the nail portions Ta of the other four fingers are approximately aligned, the photographing area of the photographing unit 30 and the printing area of the print unit 40 can be small.

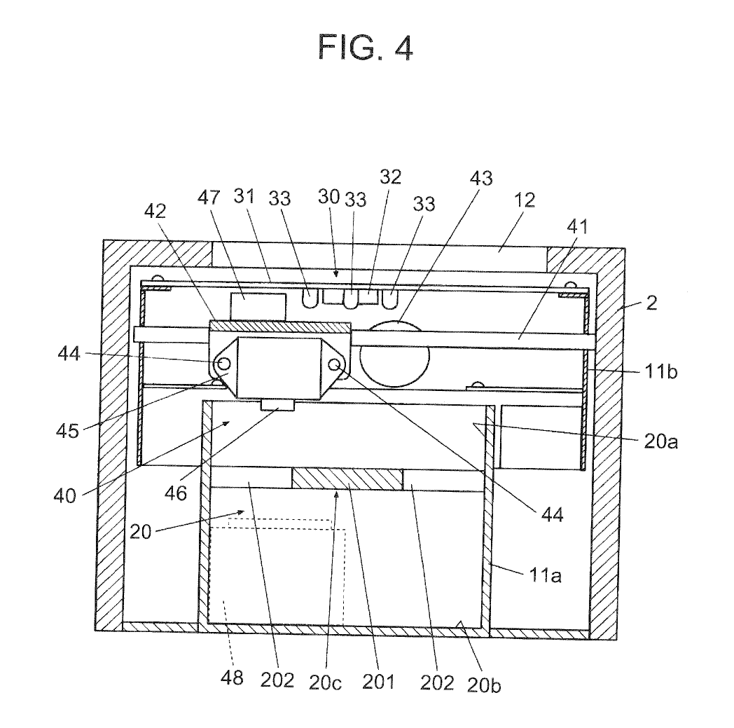

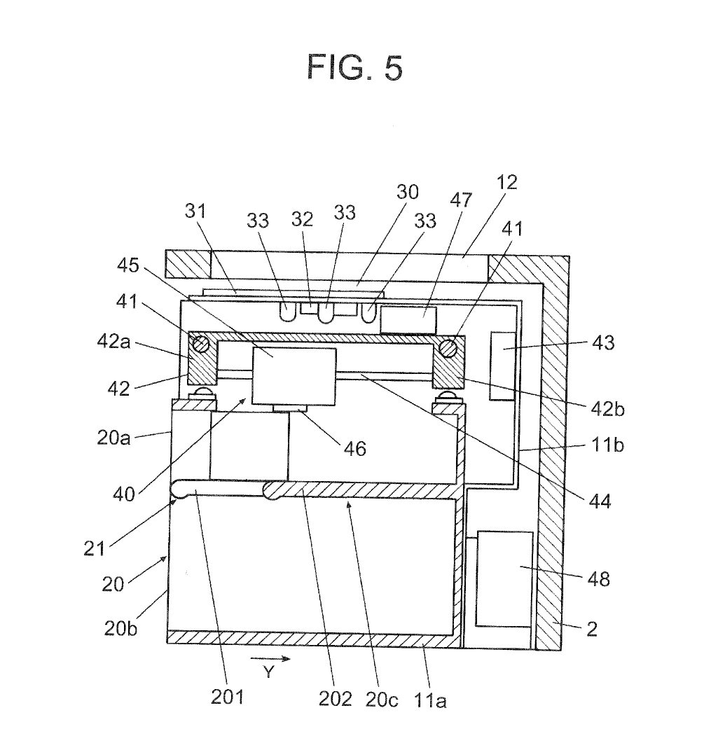

FIG. 4 is a cross-sectional view of the front of the nail print apparatus 1 of the embodiment, and FIG. 5 is a sectional side view of the nail print apparatus 1.

As shown in FIGS. 4 and 5, the photographing unit 30 is provided inside the upper machine casing 11b which is in the machine casing 11.

That is, a camera 32 having two million pixels or more, in which a driver is embedded, is provided in the center of the lower surface of the substrate 31 which is provided in the upper machine casing 11b. Further, on the substrate 31, lights 33 such as while LED are provided so as to surround the camera 32. The photographing unit 30 is configured by including the camera 32 and the lights 33.

The photographing unit 30 is for illuminating the printing fingers U1 by the lights 33 to photograph the printing fingers U1 by the camera 32 and taking in the finger image. The photographing unit 30 is connected to the control unit 51 to be controlled by the control unit 51.

Further, the print unit 40 is mainly provided in the upper machine casing 11b.

That is, as shown in FIGS. 2 and 4, two guide rods 41 are bridged in parallel between the two side boards of the upper machine casing 11b. A main carriage 42 is attached to the guide rods 41 so as to slide along the guide rods 41. As shown in FIG. 5, two guide rods 44 are bridged in parallel between the front wall 42a and the back wall 42b of the main carriage 42. A secondary carriage 45 is attached to the guide rods 44 so as to slide along the guide rods 44. A print head 46 is mounted on the secondary carriage 45 in the center of the lower surface thereof.

In the embodiment, the print head 46 is an ink-jet type print head which makes ink be in a form of micro droplets and directly sprays the ink droplets to a medium to be printed. Here, the recording method of the print head 46 is not limited to the ink-jet method.

The main carriage 42 is connected to the motor 43 via a power transmitting unit (not shown in the drawings), and the main carriage 42 moves in right and left direction along the guide rods 41 by the forward-reverse rotation of the motor 43. The secondary carriage 45 is connected to the motor 47 via a power transmitting unit (not shown in the drawings), and the secondary carriage 45 moves in front and back direction along the guide rods 44 by the forward-reverse rotation of the motor 47. In the embodiment, moving range of the print heard 46 is the printing range of the nail print apparatus 1, and printing is to be performed on the printing fingers U1 in this printing range.

Moreover, an ink cartridge 48 for supplying ink to the print head 46 is provided in the lower machine casing 11a. The ink cartridge 48 is connected with the print head 46 via an ink supply tube (not shown in the drawings), and the ink cartridge 48 arbitrarily supplies ink to the print head 46.

The print unit 40 is configured by including the guide rods 41, the main carriage 42, the motor 43, the guide rods 44, the secondary carriage 45, the print head 46, the motor 47, the ink cartridge 48 and such like.

The motor 43, print head 46 and motor 47 of the print unit 40 are connected to the after-mentioned control unit 51 (print control unit 514) of the control device 50 to be controlled by the control unit 51 (print control unit 514).

The operation unit 12 is an input unit for a user to perform various types of inputting.

For example, a power switch button 121a to turn on the power of the nail print apparatus 1, a print start instruction switch button 121b to input the starting instruction of printing and an operation buttons 121 to carry out other various types of inputs are arranged in the operation unit 12.

Further, the display unit 13 constituted of a liquid crystal panel (liquid crystal display) or the like is provided in the top board 2f of the case main body 2.

In the embodiment, a touch panel is integrally formed on the surface of the display unit 13, and various types of input operations can be performed by touching the surface of the display unit 13 by touching operation of a stylus pen or the like (not shown).

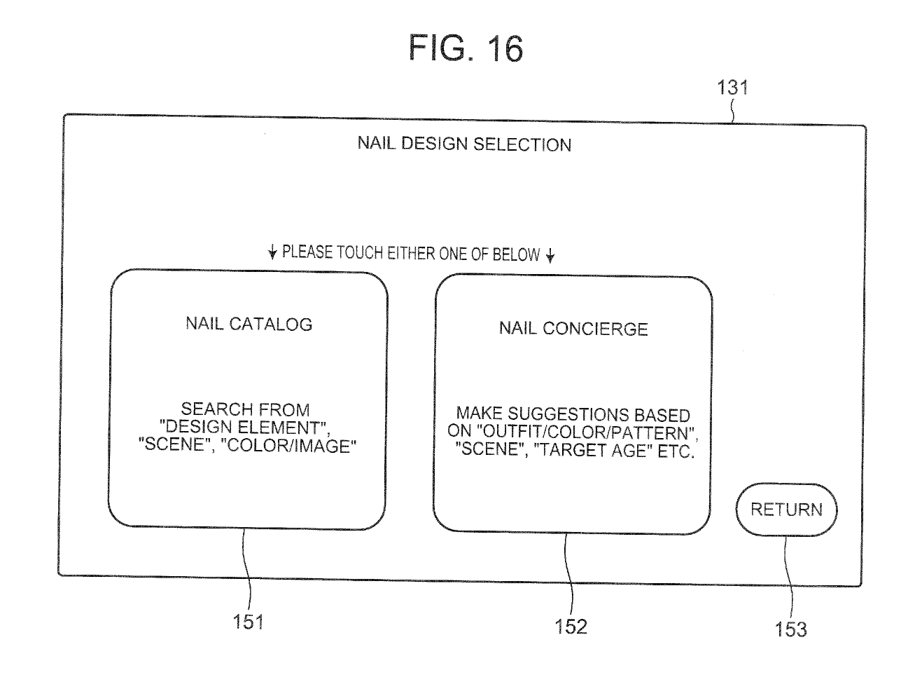

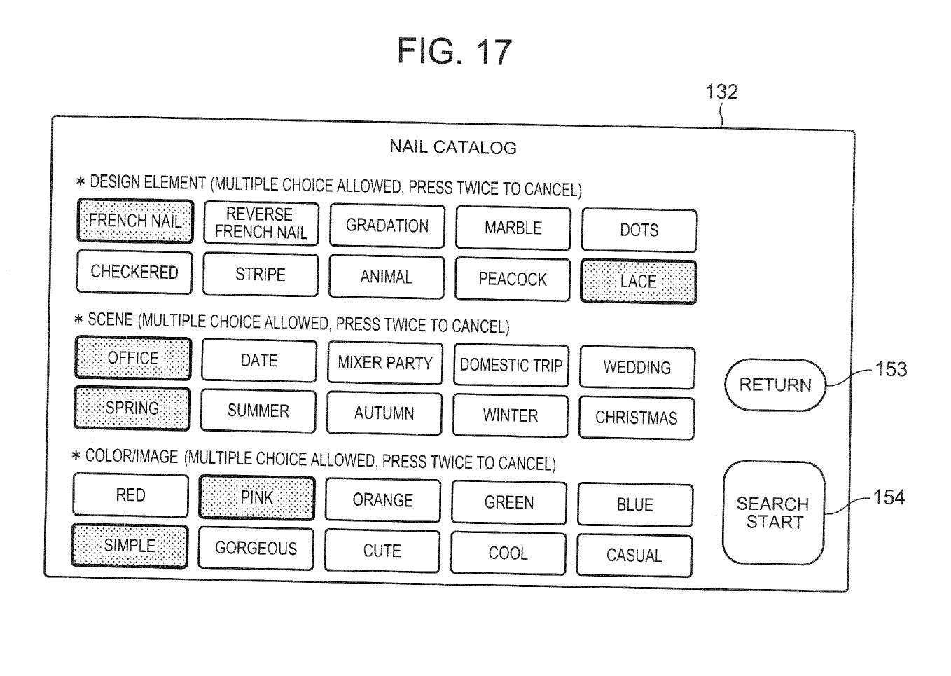

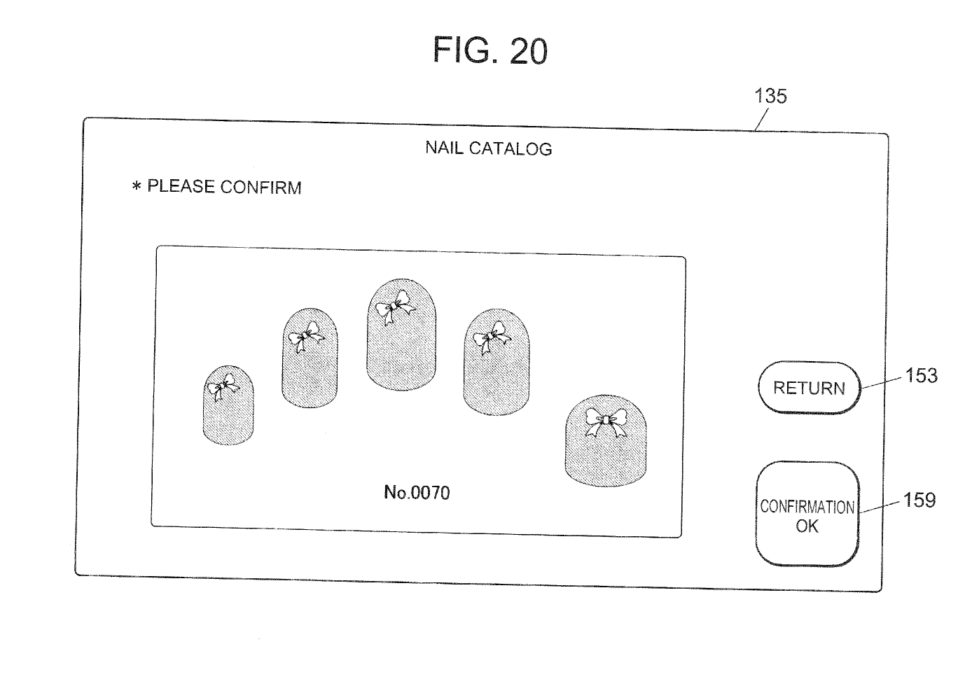

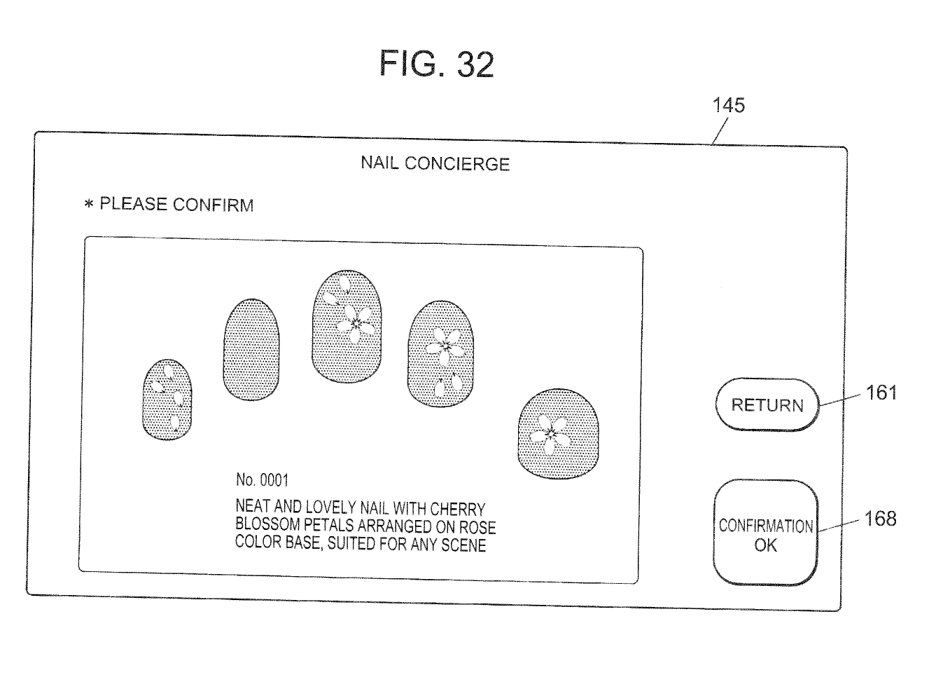

For example, various types of selection screen as shown in FIGS. 16, 19 and 31, various types of setting screens as shown in FIGS. 17 and 21 to 27, confirmation screens as shown in FIGS. 20, 32 and the like are to be displayed in the display unit 13.

In the embodiment, as will be described later, the nail print apparatus 1 performs nail design selection processing by which nail designs according to a user's request are automatically extracted among a plurality of nail designs and are suggested, and there are a nail catalog mode and a nail concierge mode as modes when performing the nail design selection processing.

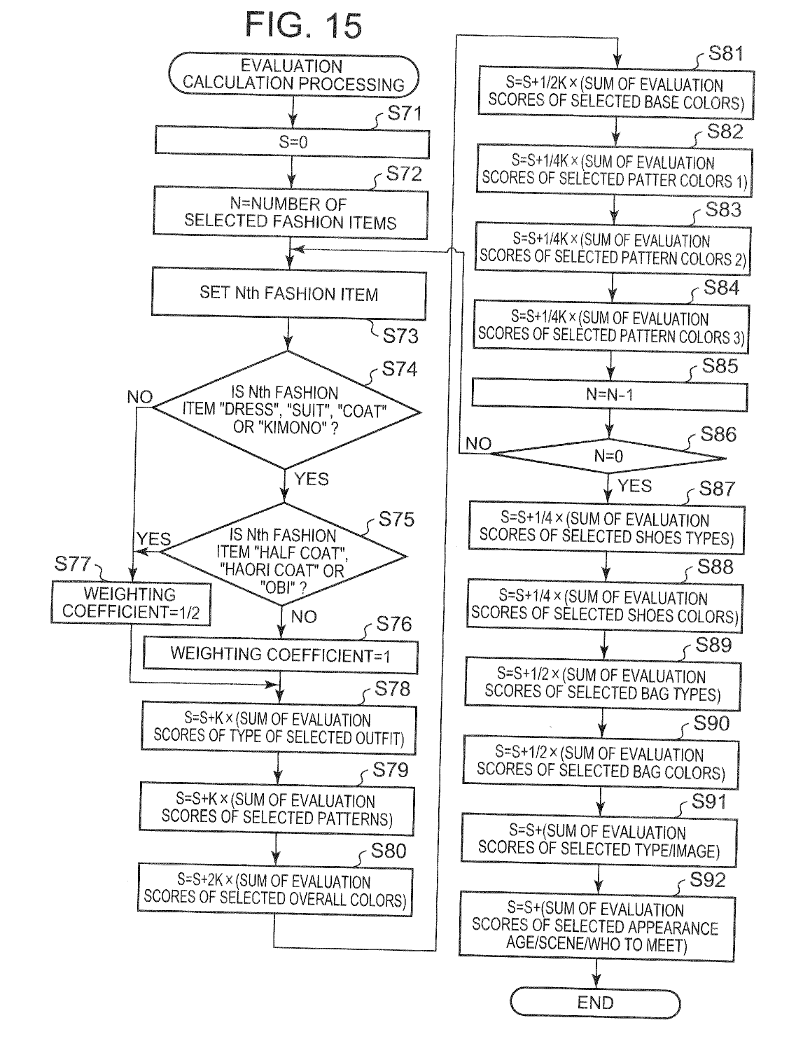

As shown in FIG. 15, for example, a mode selection screen 131 in which a nail catalog mode button 151 and a nail concierge mode button 152 are displayed is displayable in the display unit 13. By a user performing a touch operation of the nail catalog mode button 151 or the nail concierge mode button 152 in the mode selection screen 131, either of the nail design selection modes is selected. Here, a return button 153 is provided in the mode selection screen 131, and the selection result in the mode selection screen 131 is to be canceled and the screen is to return to the previous screen by operating this return button 153.

The nail print apparatus 1 not only includes the nail design selection modes that allows the nail print apparatus 1 to automatically extract nail designs, and a user herself may be able to specify a desired nail design among the plurality of nail designs.

In the nail catalog mode, the nail print apparatus 1 automatically extracts nail designs which match the specified condition among a plurality of nail designs by specifying (selecting) “design element”, “scene” and “color/image”.

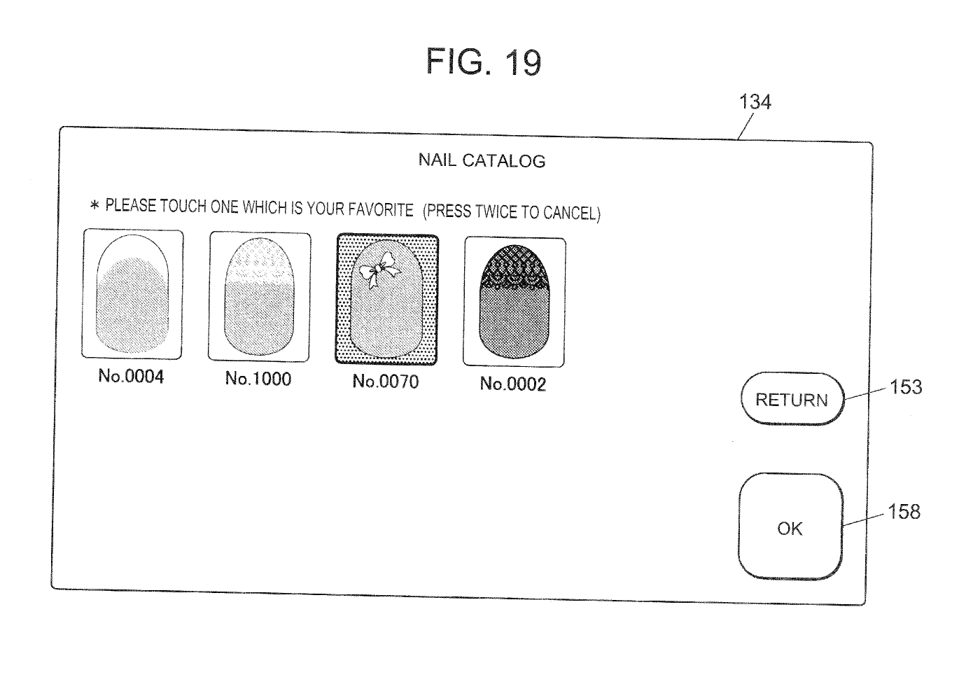

Here, “design element” means an element which constitutes each nail design and for example, a design element is “french nail” in design No. 0004, “lace” in design No. 1000, “ribbon” in design No. 0070 and “lace” in design No. 0002 as shown in FIG. 19.

“Scene” means the scene or situations of the occasion for having her nails done and for example, scene includes the places and events such as “office”, “wedding” and the like, seasons such as “spring”, “Christmas” and the like when a user wants her nails done as shown in FIG. 17.

“Color/image” means colors and images of nail designs and for example, includes “red”, “orange”, “simple”, “gorgeous” and the like as shown in FIG. 17.

These “design element”, “scene” and “color/image” are set in prior for each nail design and the information is stored in the after-mentioned storage unit such as ROM 52.

The nail concierge mode is a mode which allows the nail print apparatus 1 to automatically extract nail designs which suit the specified items among the plurality of nail designs by evaluating the matching level of each design with respect to each item when fashion related items (related items) such as “outfit/color/pattern”, “scene”, “target age” and the like are specified (selected).

Here, “fashion related items” are items to be considered when selecting nail designs and include at least a plurality of “fashion items” and a plurality of “fashion item related items” including colors of the fashion items.

“Fashion items” are items which indicate type of the outfit a user is wearing on the occasion for having her nails done and for example, include various types of outfits such as a shirt/blouse, a dress, a suit and the like.

“Fashion item related items” are items indicating color, pattern and the like of each outfit (that is, the fashion item, a dress, for example) included in “fashion items”. Here, “fashion item related items” are not limited to colors and patterns as long as the item includes at least the color of each fashion item (outfit).

“Fashion related items” are not limited to “fashion items” and “fashion item related items”, and broadly includes various items which are to be considered when selecting nail designs. For example, in the embodiment, “target age” and “scene/who to meet” are included in “fashion item related items” in addition to “fashion items” and “fashion item related item”.

“Target age” is the appearance age of a person (a user) who wishes to have her nails done. “Scene” means the scene and situations of the occasion for having her nails done and for example, includes places and events such as “office”, “wedding” and the like and seasons such as “spring”, “Christmas” and the like when a user wishes to have her nails done. Moreover, “who to meet” includes items relating to a person who a user plans to meet at the occasion for having her nails done, and includes ages, genders of the person.

The items and elements included in “fashion related items” and “fashion item related items” are not limited to those exemplified here. Other items may be included or may only include a part of those exemplified.

Evaluation score (evaluation value) of each of “fashion related items” (that are, types of outfits as “fashion items”, colors/patterns of each outfit as “fashion item related items”, “target age”, “scene”, “who to meet” and the like) which are set in advance for each nail design is stored in the after-mentioned evaluation data unit 52a for nail concierge in the storage unit such as ROM 52 or the like.

Hereinafter, each screen which is to be displayed in the display unit 13 when performing the nail design selection processing will be described in detail.

When the nail catalog mode is selected in the mode selection screen 131, the search setting screen 132 of nail catalog mode shown in FIG. 17 is displayed in the display unit 13, and search items can be set by a user touching her request items on the screen in the search setting screen 132.

Here, a return button 153 and a search start button 154 are provided in the search setting screen 132, and by operating the return button 153, the setting result in the search setting screen 132 is to be canceled and the screen returns to the previous screen (that is, the mode selection screen 131 of FIG. 16). Further, by operating the search start button 154, searching of nail design of the nail catalog mode can be performed.

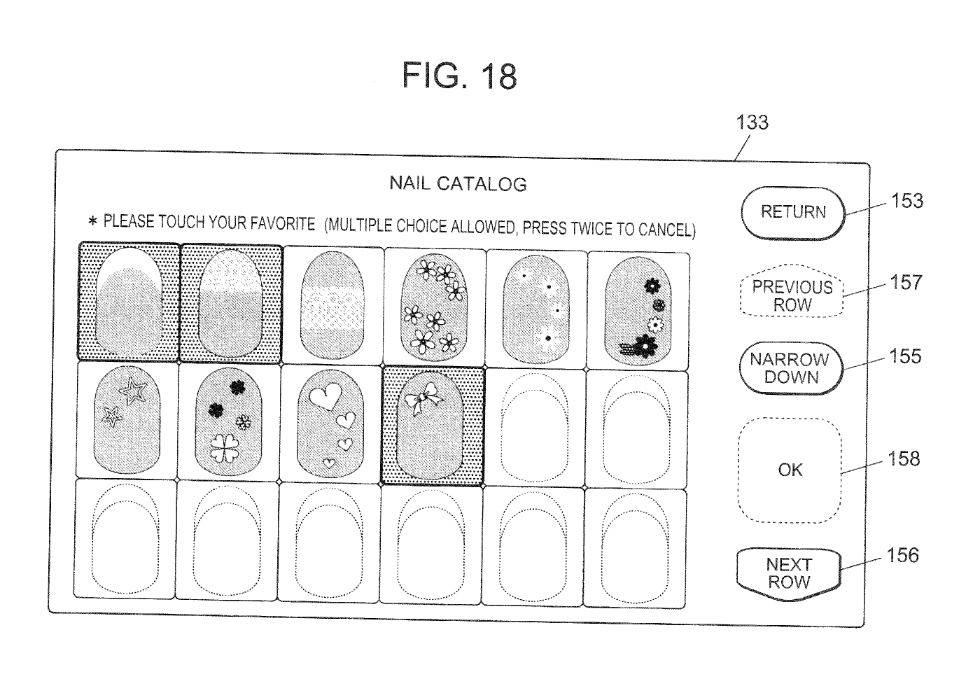

As shown in FIG. 18, the search result screen 133 which displays the search result of nail design in nail catalog mode is to be displayed in the display unit 13. In the search result screen 133, a nail design is to be selected by a user touching the desired nail design on the screen.

Here, the number of nail designs to be displayed in a search result screen 133 is not limited to the number of designs shown in the drawing. In FIG. 18, a plurality of nail designs are displayed in a screen in a chart form. However, the way of displaying the search result is not limited to this. For example, each nail design can be displayed in one screen and a plurality of nail designs can be displayed in the screen sequentially by scrolling the screen.

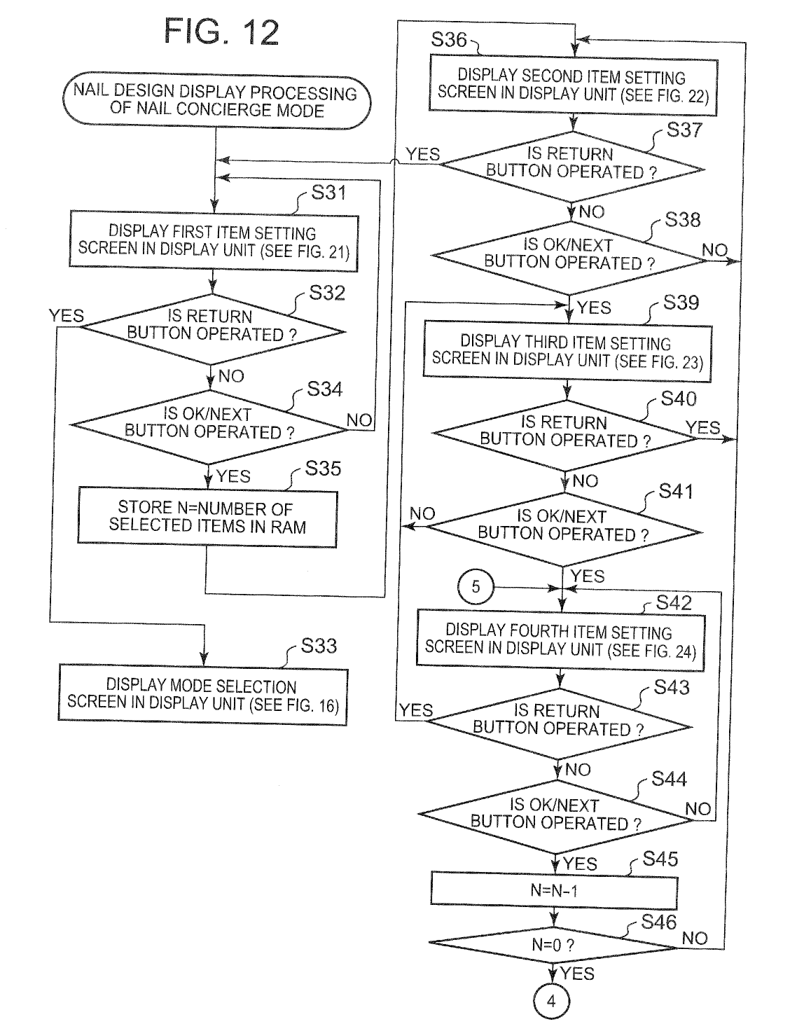

The return button 153 is provided in the search result screen 133, and by operating the return button 153, the selection result in the search result screen 133 is to be canceled and the screen returns to the previous screen (that is, the search setting screen 132 of FIG. 12). Further, by operating the next row button 156 when a user wishes to scroll to the next row and by operating the previous row button 157 when a user wishes to go back one row, the search result can be arbitrarily scrolled. The scrolling direction is not limited, and can be scrolled in the horizontal direction and not in the vertical direction as shown in FIG. 18. When a user wishes to further narrow down the search result, the searched nail designs can be further narrowed down to a user's selection by selecting a plurality of nail designs a user prefers and operating the narrow down button 155. Here, when there is only one nail design that a user prefers, the one nail design will be selected. In such case, the OK button 158 is to be displayed on the screen, and the selected nail design is to be selected as the nail design desired by a user by operating the OK button 158.

FIG. 19 is a diagram showing an example of design selection screen 134 in a state where nail designs are narrowed down to four. As shown in FIG. 19, the return button 153 and the OK button 158 are provided in the design selection screen 134, and when the return button 153 is operated, the selection result in the design selection screen 134 is to be canceled and the screen returns to the previous screen (that is, the search result screen 133 of FIG. 18). Further, when a user selects any of the nail designs and operates the OK button 158, the selected nail design (design No. 0070 in FIG. 19) is to be highlighted to be selected as the desired nail design.

FIG. 20 is an example of design confirmation screen 135 of nail catalog mode. When one nail design is selected in the design selection screen 134 (or in the search result screen 133), the design confirmation screen 135 is to be displayed. The design confirmation screen 135 shows a state where the selected nail design is printed on the nail portions of the five fingers, from the thumb to the little finger. When a user operates the return button 153 in the design confirmation screen 135, the screen returns to the previous screen (that is, the design selection screen 134 of FIG. 19). When a user operates the confirmation OK button 159, the nail design (design No. 0070 in FIG. 20) is to be decided as the nail design to be printed on the nail portions of a user.

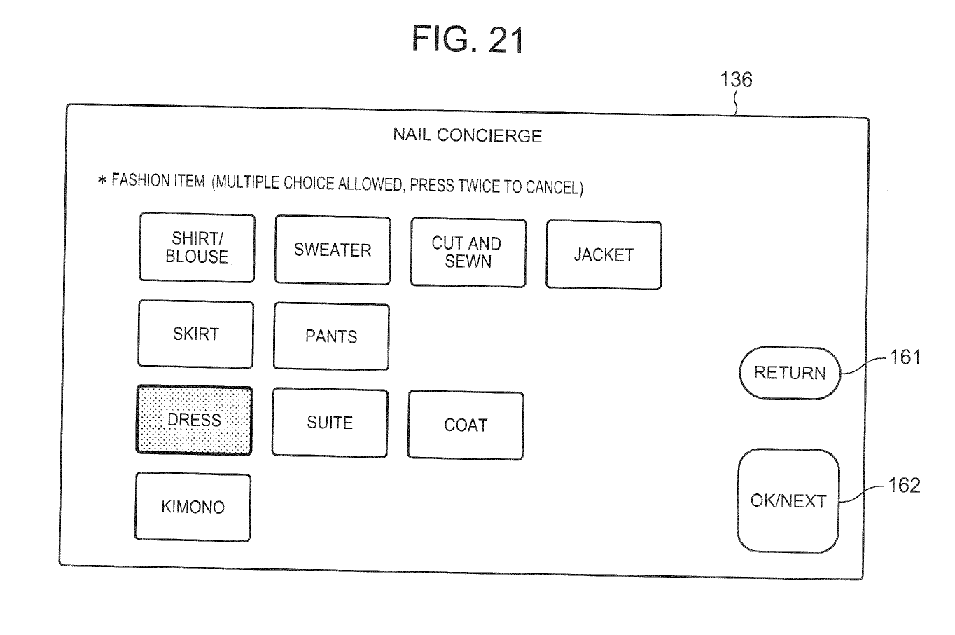

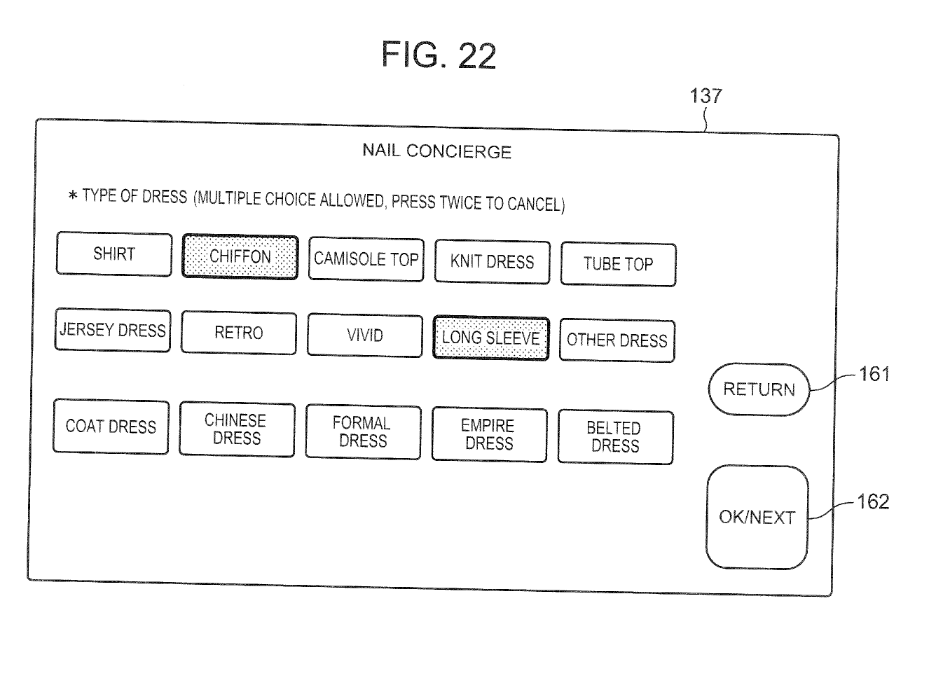

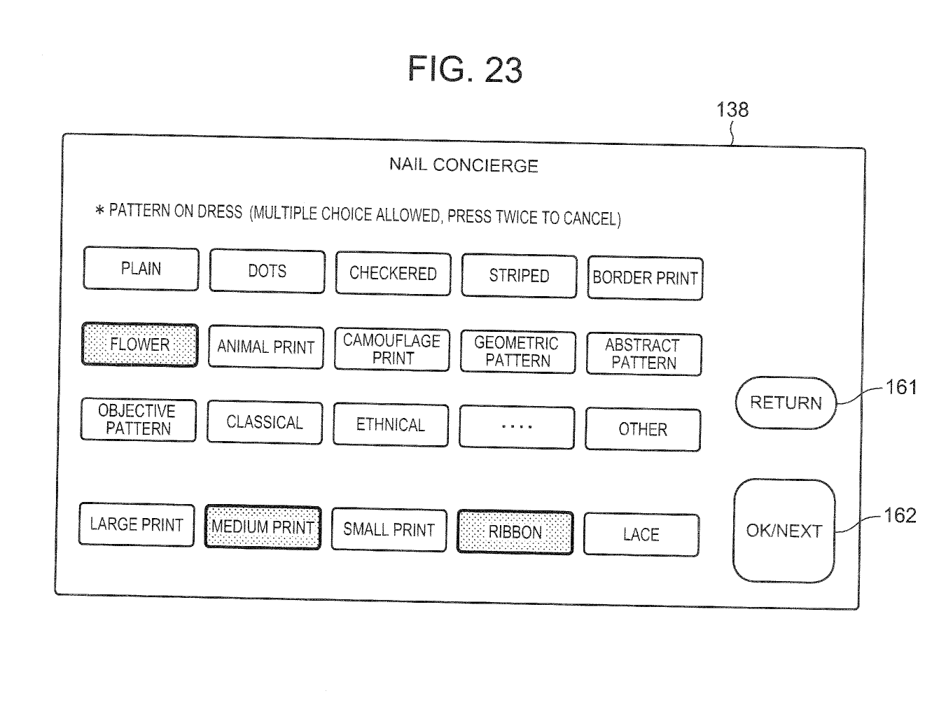

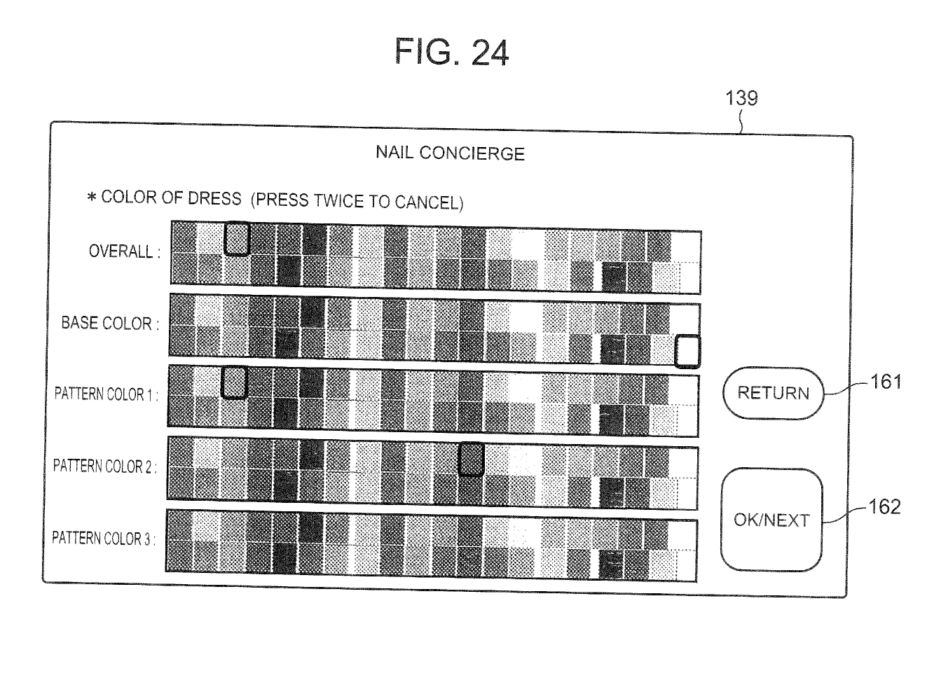

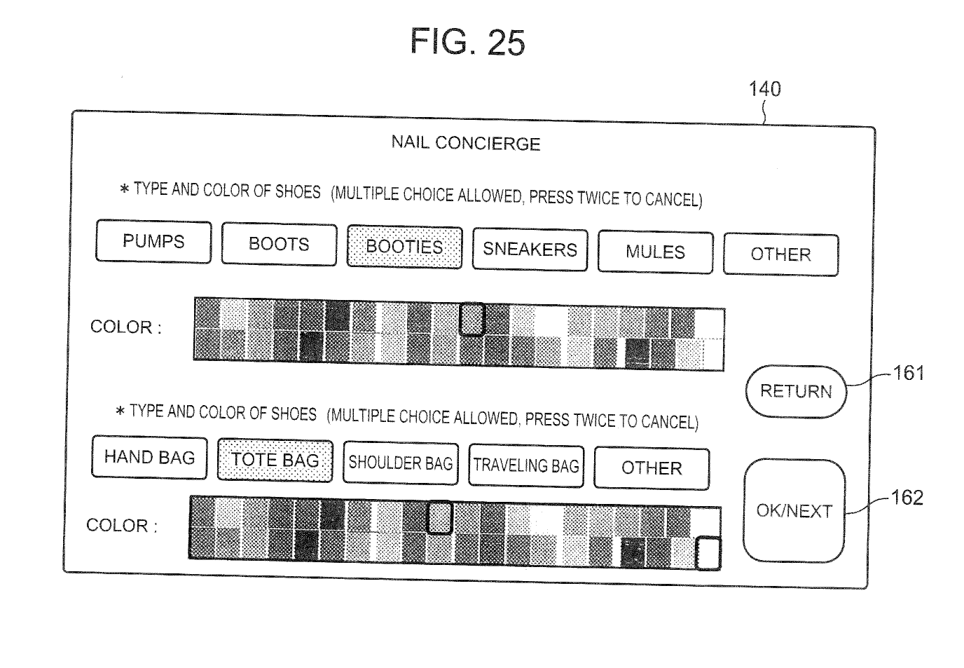

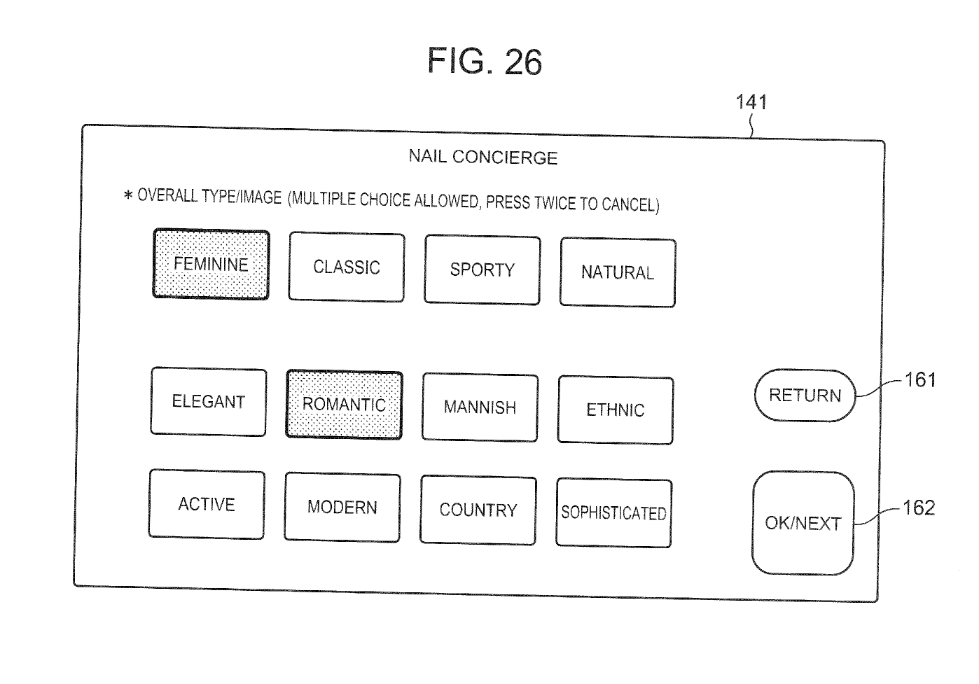

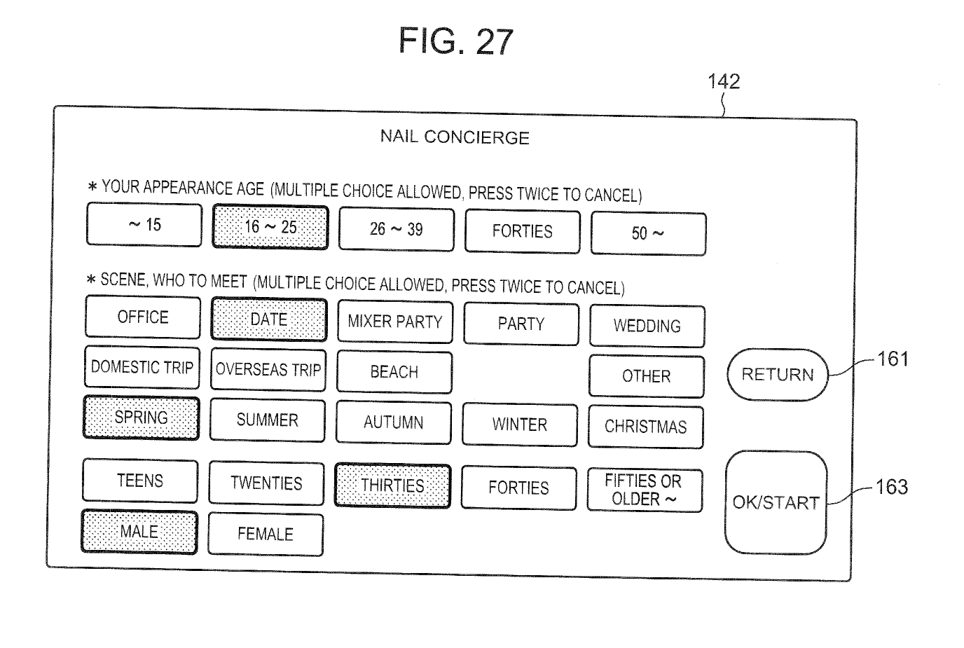

Moreover, when the nail concierge mode is selected in the mode selection screen 131, types of outfits (see FIGS. 21 and 22), patterns of outfits (see FIG. 23), colors of outfits (see FIG. 24), types/colors of shoes, types/colors of bags (see FIG. 25), overall type/image (see FIG. 26) and target age/scene/who to meet (see FIG. 27) which are a plurality of fashion related item (described later) are to be displayed in the display unit 13 respectively in the item setting screens 136 to 142 of the nail concierge mode shown in FIGS. 21 to 27. The display unit 13 functions as the display unit for displaying a plurality of fashion related items.

In the item setting screen 136 to 142, a user touches the desired items on each screen. Thereby, the desired fashion related items can be set. In the embodiment, the display unit 13 also functions as an item specifying unit for specifying one or a plurality of fashion related item among the plurality of fashion relates items displayed in the display unit 13.

FIG. 21 shows the first item setting screen 136 for setting the large category of an outfit. FIG. 22 shows the second item setting screen 137 for setting more detailed categories of “dress” when “dress” is selected in the first item setting screen 136 of FIG. 21. FIG. 23 is the third item setting screen 138 for setting the pattern of the “dress” when “dress” is selected in the first item setting screen 136 of FIG. 21. FIG. 24 is the fourth item setting screen 139 for setting the colors of the “dress” when “dress” is selected in the first item setting screen 136 of FIG. 21. In this screen for setting colors, for example, when the outfit is a plain dress, color is to be selected only for the item “overall” in FIG. 24. Further, when the outfit is a dress with pattern, image of the overall color when the dress is seen from a medium distance is to be selected for the color of the item “overall”, base color of the fabric is to be selected for the item “base color” and color of pattern is to be selected for the item “pattern color”. Here, when the pattern consists of only one color, color is to be selected only for the item “pattern color 1” and when the pattern consists of a plurality of colors, colors are to be selected for the items “pattern color 1”, “pattern color 2” and “pattern color 3” from the color which stands out the most in a descending order.

The return button 161 is provided in each of the item setting screens 136 to 142 (FIGS. 21 to 27), and by operating the return button 161, the setting result in each of the item setting screens 136 to 142 is to be canceled and the screen returns to the previous screen. Further, OK/next button 162 is provided in each of the item setting screens 136 to 141 (FIGS. 21 to 26), and by operating the OK/nest button 162, the item setting in each of the item setting screens 136 to 141 is decided and moves on to either of the item setting screens 137 to 142 which comes next. The OK/start button 163 is provided in the item setting screen 142 (FIG. 27). By operating the OK/start button 163, the item setting in the item setting screen 142 is decided and ranking (described later) of nail designs under nail concierge mode is to be performed by the after-mentioned ranking determination unit 513 of the control unit 51 using the set items.

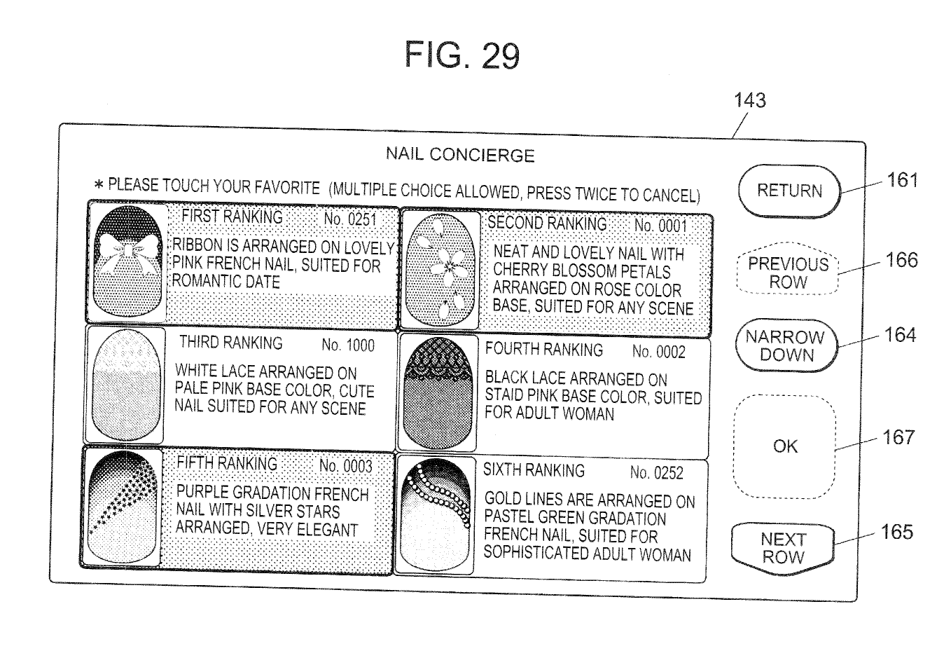

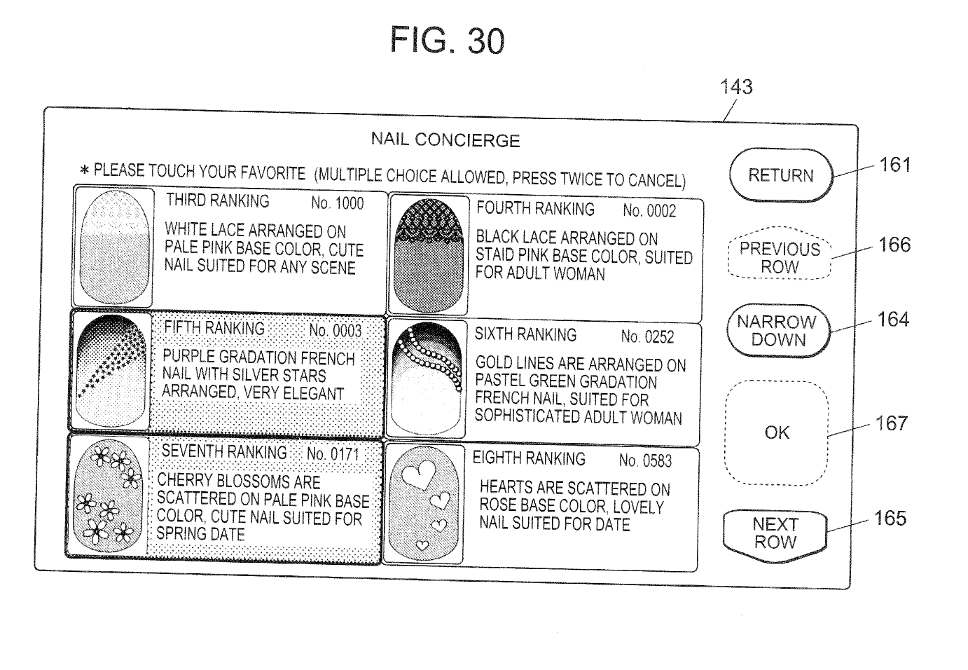

Moreover, as shown in FIGS. 29 and 30, the evaluation result screen 143 in which the ranking result is displayed is to be displayed on the display screen of the display unit 13.

In the evaluation result screen 143 of the display unit 13, at least one nail design is displayed from the highest ranking design in a descending order according to the ranking performed by the after-mentioned ranking determination unit 513 of the control unit 51. In the embodiment, six designs from the first ranking design to the sixth ranking design are displayed in one screen in a descending order. As shown in FIGS. 29 and 30, comment data indicating the feature of the nail design in addition to the rank and design No. of each nail design is displayed along with each nail design in the evaluation result screen 143. Here, the display contents of the evaluation result screen 143 are not limited to those exemplified here. Only a part of those exemplified may be displayed, or items other than those exemplified here can be displayed.

By a user touching a plurality of desired nail designs on the screen in the evaluation result screen 143, the plurality of nail designs are selected and by operating the narrow down button 164, the evaluation result is to be narrowed down to the selected nail designs.

Here, the number of nail designs to be displayed in one evaluation result screen 143 is not limited to the example shown in the drawing. FIGS. 29 and 30 show an example where a plurality of nail designs are displayed in one screen in a chart form. However, the way of displaying the evaluation result is not limited to this. For example, each nail design can be displayed in each screen and a plurality of nail designs can be displayed in the screen sequentially by scrolling the screen.

When there is only one nail design that a user prefers, by selecting the one nail design and operating the OK button 167, the selected nail design is to be selected as the desired nail design.

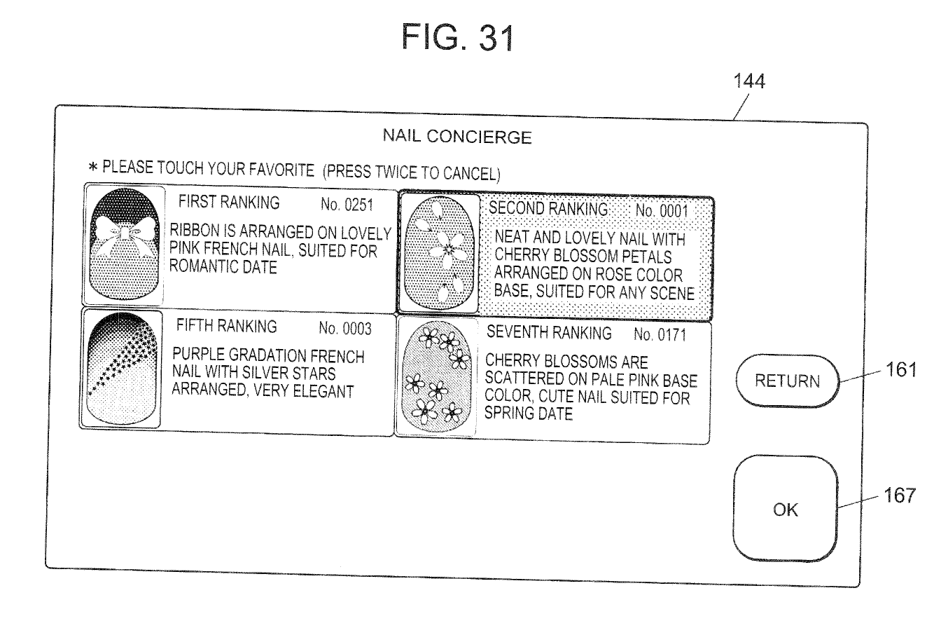

FIG. 31 is a diagram showing an example of design selection screen 144 where nail designs are narrowed down to four designs. As shown in FIG. 31, the return button 161 and the OK button 167 are provided in the design selection screen 144, and when the return button 161 is operated, the screen returns to the previous screen (that is, the evaluation result screen 143 of FIG. 29). Further, when a user selects any of nail designs and operates the OK button 167, the selected nail design (design No. 0001 in FIG. 31) is to be highlighted and selected as the desired nail design.

FIG. 32 is an example of design confirmation screen 145 of nail concierge mode. When one nail design is selected in the design selection screen 144 (or in the evaluation result screen 143), the design confirmation screen 145 is displayed. The design confirmation screen 145 indicates a state where the selected nail design is printed on the nail portions of the five fingers, from the thumb to the little finger. When a user operates the return button 161 in the design confirmation screen 145, the screen returns to the previous screen (that is, the design selection screen 144 of FIG. 31). Further, when the confirmation OK button 168 is operated, the nail design (design No. 0001 in FIG. 32) is decided as the nail design to be printed on the nail portions of a user.

In addition, a finger and nail image which is a photographed image of the printing fingers U1, an image of nail region showing nail portions T in the fingers and nail image, various types of instruction screens and the like are to be displayed in the display unit 13 arbitrarily.

The display unit is connected to the control unit 51 (display control unit 515) and is to be controlled by the control unit 51 (display control unit 515).

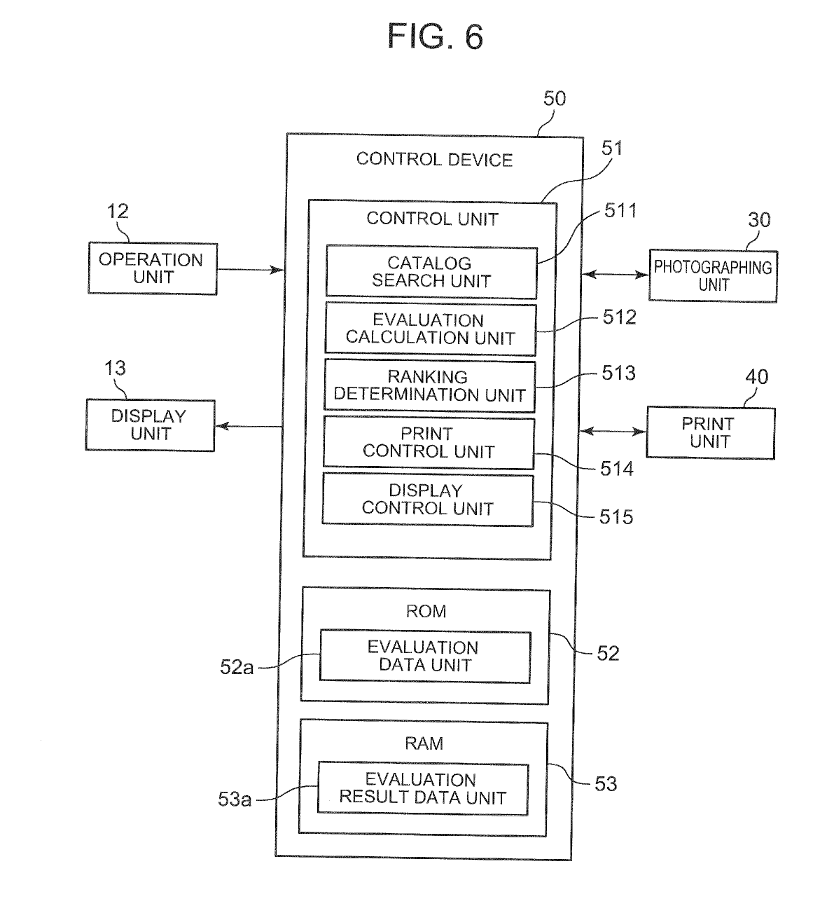

Moreover, the control device 50 is disposed on the substrate 31 or the like disposed in the upper machine casing 11b. FIG. 6 is a main part block diagram showing the control configuration in the embodiment.

As shown in FIG. 6, the control device 50 is a computer including a control unit 51 configured of CPU (Central Processing Unit) which is not shown in the drawings, the ROM 25 (Read Only Memory) and the RAM 53 (Random Access Memory) as the storage unit. Here, the storage unit is not limited to the ROM 52 and RAM 53 inside the control device 50, and other storage unit can be provided.

When mechanically seen, the control unit 51 includes the catalog search unit 511, the evaluation calculation unit 512, the ranking determination unit 513, the print control unit 514, the display control unit 515 and the like. The functions of catalog search unit 511, evaluation calculation unit 512, ranking determination unit 513, print control unit 514, display control unit 515 and the like are realized by cooperation between the CPU and the programs stored in the ROM 52.

In the embodiment, various types of programs such as a nail catalog search program for automatically selecting a nail design in nail catalog mode, a nail concierge evaluation program for automatically selecting a nail design in nail concierge mode, a display control processing program for performing display control processing and print control processing program for performing print control processing are stored in the ROM 52. By these programs being executed by the control device 50, each part of the nail print apparatus 1 is integrally controlled.

In the embodiment, a catalog search data unit (not shown in the drawings) for storing data for nail catalog is provided in the ROM 52. For example, nail designs corresponding to each of the items of “design element”, “scene” and “color/image” are set and stored in advance in the catalog search data unit.

The number of items to be stored in the catalog search data unit and the types thereof are not specifically limited. However, if there are too many items stored for one nail design, data amount occupied by the data for nail catalog becomes large and a storage unit with large capacity will be needed.

Therefore, in the embodiment, data of about 10 byte can be held by each nail design as data for nail catalog mode to be stored in the catalog search data unit. Specifically, for example, four data relevant to “design element”, two data relevant to “scene”, two data relevant to “color” (when a nail design consist of three colors or more, the color which is used the most and the color which used second to most are to be registered in the catalog search data unit), two data relevant to “image” are respectively the maximum to be stored.

Moreover, in the embodiment, an evaluation data unit 52a for storing data for nail concierge is provided in the ROM 52. Data of a plurality of nail designs (bitmap data of nail design images and the like) is stored in the evaluation data unit 52a for nail concierge, by each data being associated with the design number that indicates the nail design (design No.), a comment data that indicates feature of the nail design (text data), each evaluation score (evaluation value) of “fashion related items” (that is, the type of outfit as “fashion item”, color/pattern of outfits as “fashion item related items”, “target age”, “scene”, “who to meet” and the like) which are set in advance for each nail design.

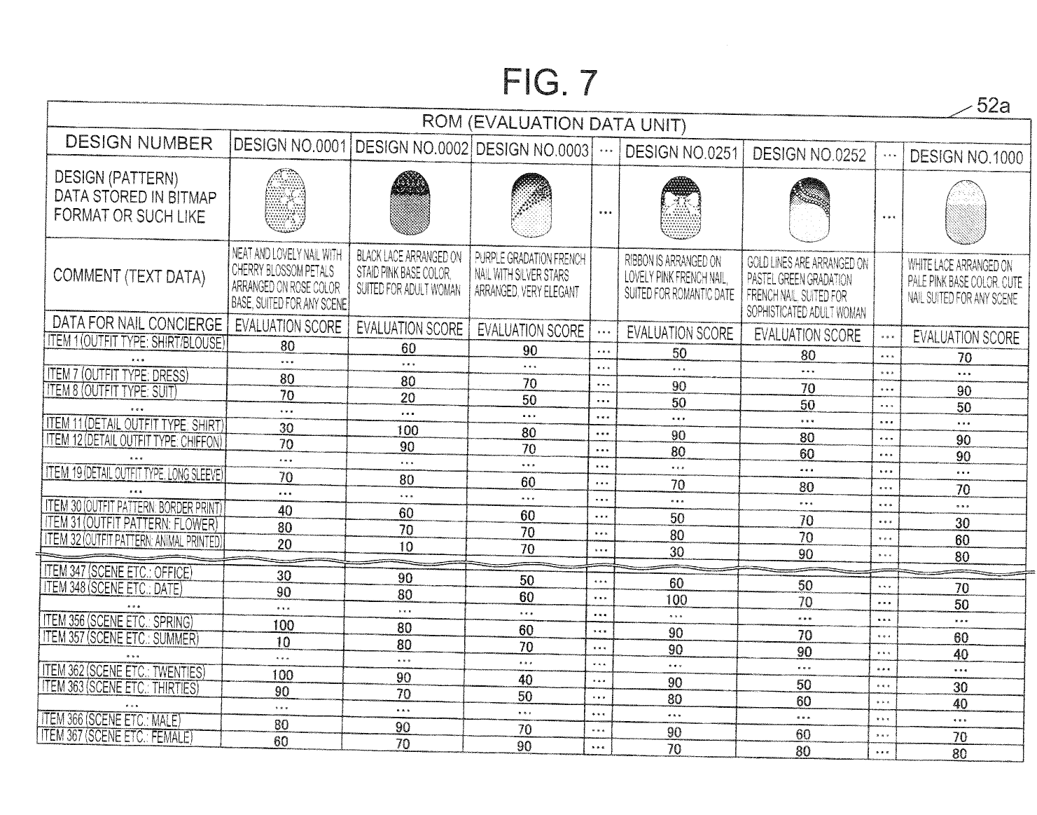

FIG. 7 is a diagram showing a configuration example of evaluation data unit 52a for nail concierge of the embodiment.

Each evaluation score (evaluation value) shown in FIG. 7 is numeral values indicating the matching level between each of the nail designs and each of the fashion related items. As shown in FIG. 7, in the embodiment, each evaluation score which is a matching evaluation between each of the total of 367 items (see FIGS. 21 to 27) as fashion related items, from “types of outfit (fashion items)” to “scene/who to meet”, and each nail design converted into points that is evaluated by a fashion designer, for example, in advance is stored.

The way of converting the evaluation into score is not specifically limited. However, in the embodiment, matching with each nail design is evaluated in points between +127 to −127 for each item. Point evaluation is performed for all of the items, and for example, 20 items are prepared for patterns of outfits as shown in FIG. 23. Further, as colors of outfits, 40 colors are prepared for each of overall color, base color and pattern colors 1 to 3, that is total of 200 items. Here, types, colors and number of patterns are not limited to those exemplified. For example, the number of items for colors of outfits may be about 12 colors or about 10 colors. As shown in FIG. 7, evaluation score indicating the matching level with each nail design is stored in the evaluation data unit 52a for each item so as to correspond to each nail design. Here, because the evaluation data is stored as evaluation scores, the data amount can be about 1 byte even when there is large number of items.

In the embodiment, the ROM 52 functions as the first storage circuit which stores a plurality of nail designs therein so that each nail design corresponds to an evaluation value that indicates the matching level of the nail design with respect to each of the plurality of fashion related items.

Further, The RAM 53 includes a storage region for storing various types of data and the like and a working region (not shown in the drawings) where the control unit 51 expands programs and like when performing various types of processing.

In the embodiment, the evaluation result data unit 53a for storing the evaluation results calculated by the evaluation calculation unit 512 which is evaluation calculation unit is provided in the storage region of the RAM 53, and the RAM 53 functions as the second storage circuit for storing the evaluation results calculated by the evaluation calculation unit 512.

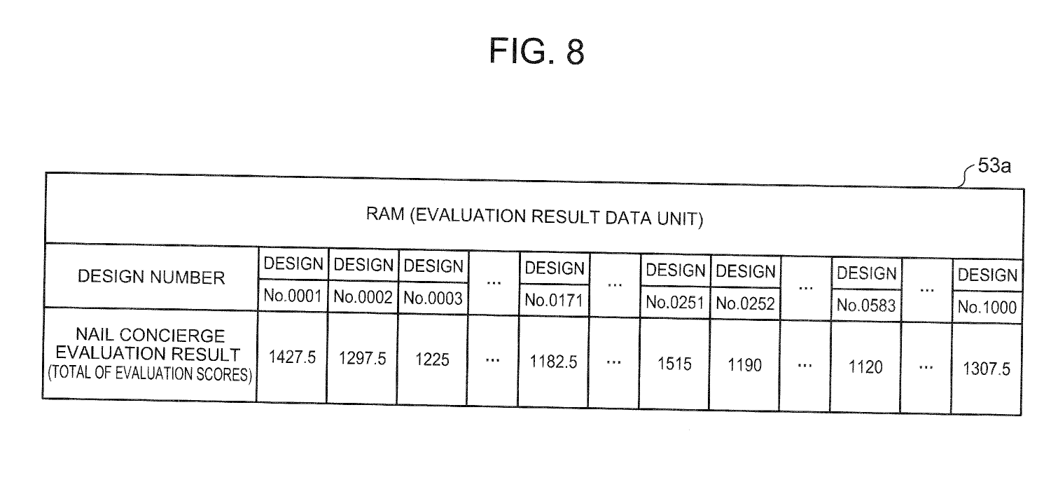

FIG. 8 is a diagram showing a configuration example of the evaluation result data unit 53a for nail concierge of the embodiment.

As shown in FIG. 8, evaluation results (that are, total points of evaluation scores), each of which is calculated by adding up the evaluation scores (evaluation values) for each nail design by the evaluation calculation unit 512 which is the evaluation calculation unit, are stored in the evaluation result data unit 53a so as to correspond respectively to the design number of each of the nail designs.

Here, evaluation results of all of the nail designs calculated by the evaluation calculation unit 512 may be sequentially stored in the evaluation result data unit 53a. Alternatively, for example, the evaluation score can be compared to the evaluation results of nail designs which are already calculated every time the evaluation calculation unit 512 calculated an evaluation score, and the evaluation results of nail designs having high evaluation results ranking within top twelfth ranking may be stored, for example. As for the nail designs ranking lower, their data may not be stored.

When the nail catalog mode is selected as the design selection mode to select nail designs, the catalog search unit 511 selects nail designs that match the search items set by a user among a plurality of nail designs.

In particularly, the catalog search unit 511 search whether the search items specified (set) by a user are associated with each of the nail designs starting from design No. 0001, and +1 point is added as it is detected that each of the search items is associated.

For example, when the search items specified (set) by user are “french nail”, “lace, “office”, “spring” “pink” and “simple” as shown in FIG. 17 and when in design No. 0004, the “design element” associated is “french nail”, the “scene” associated are “office” and “spring”, the “color/image” associated are “pink” and “simple”, design No. 0004 includes five items which are “french nail”, “office”, “spring”, “pink” and “simple among the items set by a user. Therefore, the score added to design No. 0004 is to be +5. Further, for example, when in design No. 0002, the “design element” associated is “lace”, the “scene” associated are “date” and “autumn”, the “color/image” associated are “pink” and “cool”, design No. 0002 includes two items which are “lace” and “pink” among the items set by a user. Therefore, the score added to design No. 0002 is to be +2.

Such search is to be performed on all of the nail designs (in the embodiment, 1000 nail design which are from design No. 0001 to design No. 1000) stored in the ROM 52, and the search result includes top 36 designs having large points added thereto in a descending order. The search result of the catalog search unit 511 is displayed in the display unit 13 (see FIG. 18). Here, how may of the upper ranking nail designs are to be displayed as the search result is not specifically limited. For example, only those obtained more than a certain score may by stored as the search result.

The evaluation calculation unit 512 is an evaluation calculation unit which calculates the evaluation result for each nail design by reading out and adding up the evaluation scores (evaluation values) of the fashion related items specified in the touch panel of the display unit 13, which is the item specifying unit, with respect to each nail design stored in the ROM 52 which is the first storage circuit.

Here, in the embodiment, weighting of evaluation score is changed according to the type of fashion item (that is, the outfit of a user) which is specified. For example, when the fashion item is one of “dress”, “suit”, “coat” and “kimono”, the weighting coefficient is 1, and when the fashion item is one of “half coat”, “haori coat” and “obi”, the weighting coefficient is ½. Further, as for colors and patterns of fashion items, they are heavily valued (for example, the weighting coefficient K is multiplied by 2) for those play a great hole in match with a nail design (for example, overall color of the outfit or the like). On the other, hand, if the items play only a minor role (for example, color of a pattern applied to a part of the outfit or the like), they are lightly valued (for example, the coefficient K is multiplied by ¼). In such way, more suitable matching can be realized when a nail design is coordinated with an outfit or the like. Here, the method of weighting by the evaluation calculation unit 512 is not limited to what is exemplified. Such weighting is not required in the evaluation calculation unit 512, and each evaluation result can be calculated by reading out the evaluation score (evaluation value) of each fashion related item and merely adding them up without performing weighting.

The ranking determination unit 513 is a ranking determination unit for performing ranking of each nail design by comparing the evaluation result of each nail design stored in the valuation result data unit 53a of the RAM 53 which is the second storage circuit to each other.

In particular, when the evaluation calculation unit 512 calculated the evaluation result of a nail design, the ranking determination unit 513 compares the newly calculated evaluation result to the evaluation results which are already stored in the evaluation result data unit 53a, if there is any, and sets the design having the highest score as provisional first ranking. Further, when there is no evaluation result stored in the evaluation result data unit 53a yet (for example, the first to be evaluated such as the evaluation result of design No. 0001 or the like), the nail design is set as provisional first ranking.

Here, in a case where only the evaluation results of the nail designs having a predetermined high evaluation are to be stored in the evaluation result data unit 53a, the predetermined high evaluation being twelfth ranking or higher, for example, with respect to those nail designs determined that their evaluation results are twelfth ranking or lower as a result of comparison performed by the ranking determination unit 513, their evaluation results can be sequentially thrown out and only the evaluation results of the nail designs whose evaluation results rank twelfth ranking or higher are to be stored in the evaluation result data unit 53a at any time.

The print control unit 514 is a print control unit for controlling the print unit 40 to perform printing of the nail design which is selected in the nail catalog mode or in the nail concierge mode or the like on nail portion of a user.

The display control unit 515 is a display control unit for making the display unit 13 display various types of screens and the like.

In the embodiment, the display control unit 515 functions as the first display control unit for making the display unit 13 display a plurality of fashion related items. That is, the display control unit 151 controls the display unit 13 so that the item setting screens (FIGS. 21 to 27) in which a plurality of fashion related items are displayed in a chart form are to be displayed in the display unit 13. Here, although a case where a plurality of fashion related items are displayed in on display screen is shown as an example in the embodiment, the way of displaying the fashion related items is not limited to the way shown in the embodiment. For example, the fashion related items can be displayed in the screen one by one and the fashion related items can be displayed sequentially by switching the display screen or by scrolling the screen.

Moreover, the display control unit 515 functions as the second display control unit for making the display unit 13 display at least one nail design in an order starting from the highest tanking design according to the ranking performed by the ranking determination unit 513. Here, in the embodiment, a case where six nail designs are displayed along with their comments and design numbers in three rows and two columns in one evaluation result screen 143 on the display unit 13 is shown as an example. However, the number of nail designs to be display in the evaluation result screen 143, the way of layout when displaying the nail designs, the items to be displayed and the like are not limited to those exemplified in the embodiment. For example, the nail designs can be displayed in the screen one by one, and the nail designs can be displayed sequentially in a descending order from the higher ranking design by switching the display screen or by scrolling the screen.

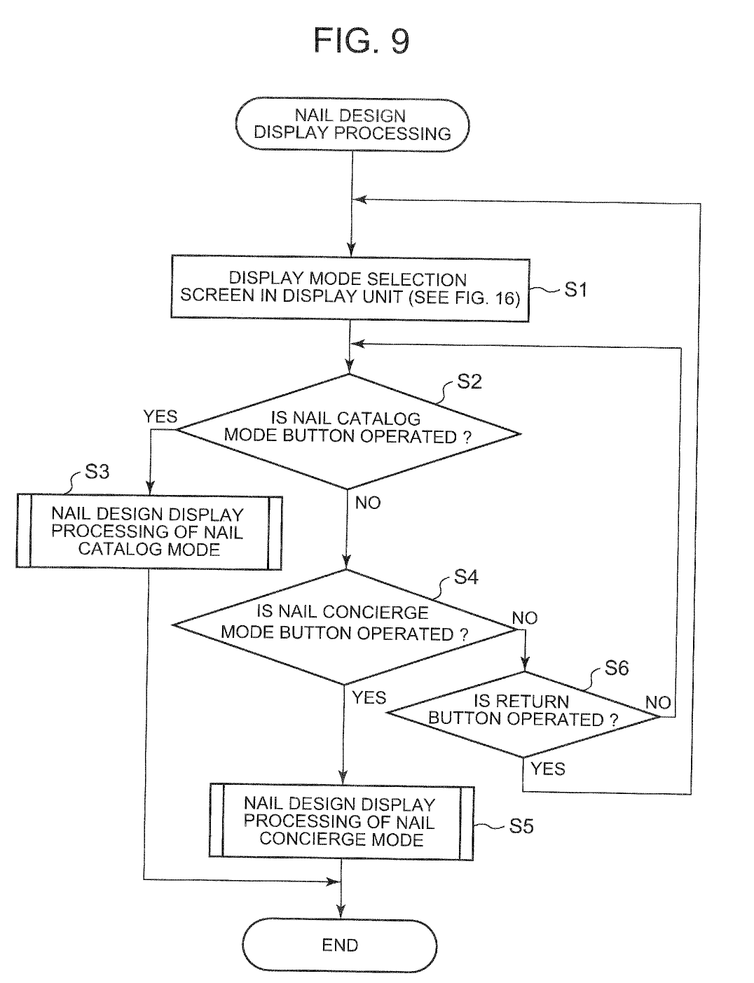

Next, the display control method of nail designs in the nail print apparatus 1 will be described with reference to the flowcharts shown in FIGS. 9 to 15 and diagrams of FIGS. 16 to 32.

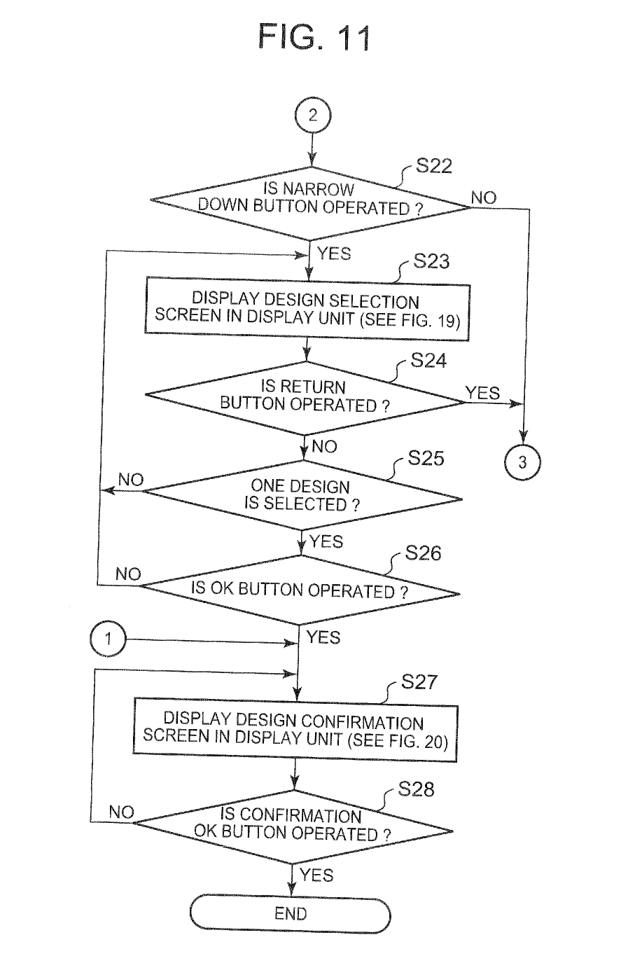

As shown in FIG. 9, when the nail design display processing is to be performed in the embodiment, the mode selection screen 131 (see FIG. 16) for selecting either of the nail catalog mode or the nail concierge mode as nail design selection mode for selecting nail designs to be displayed in the display unit 13 is displayed in the display unit 13 (step S1). The control unit 51 determines whether the nail catalog mode button 151 is operated in the mode selection screen 131 (step S2). When it is determined that the nail catalog mode button 151 is operated (step S2; YES), the control unit 51 performs the nail design display processing of nail catalog mode (see FIGS. 10 and 11) (step S3).

On the other hand, when it is determined that the nail catalog mode button 151 is not operated (step S2; NO), the control unit 51 further determines whether the nail concierge mode button 152 is operated in the mode selection screen 131 (step S4). When it is determined that the nail concierge mode button 152 is operated (step S4; YES), the control unit 51 performs the nail design display processing of nail concierge mode (see FIGS. 12 to 15) (step S5). When it is determined that the nail concierge mode button 152 is not operated (step S4; NO), the control unit 51 further determines whether the return button is operated (step S6). When it is determined that the return button 153 is not operated (step S6; NO), the control unit 51 returns to step S2 and determines whether the nail catalog mode button 151 is operated. When it is determined that the return button 153 is operated (step S6; YES), the control unit 51 returns to step S1 and makes the display unit 13 display the mode selection screen 131.

FIGS. 10 and 11 show a flowchart of a case when the nail design to be displayed in the display unit 13 is selected in nail catalog mode and the nail design display processing is performed (that is, step S3 in FIG. 9).

When the nail catalog mode button 151 is operated in the mode selection screen 131 and the nail catalog mode is selected, the search setting screen 132 (see FIG. 17) is displayed in the display unit 13 (step S11). As shown in FIG. 17, a plurality of items are displayed for each of “design element”, “scene” and “color/image” in the search setting screen 132, and by a use touching the display screen, design elements which constitute the desired nail design, place and season of the occasion for having her nails done, color and image of the desired nail can be selected. The selected items are to be highlighted, and the selection can be canceled by pressing the item twice. The control unit 51 determines whether the return button 153 is operated in the search setting screen 132 (step S12). When it is determined that the return button 153 is operated (step S12; YES), the control unit 51 makes the display unit 13 display the previous screen, that is, the mode selection screen 131 (see FIG. 16) (step S13) and repeats the processing shown in FIG. 9.

On the other hand, when it is determined that the return button 153 is not operated (step S12; NO), the control unit 51 further determines whether the search start button 154 is operated (step S14). When it is determined that the search start button 154 is not operated (step S14; NO), the control unit 51 returns to step S11 and makes the display unit 13 display the search setting screen 132. When the control unit 51 determines that the search start button 154 is operated (step S14; YES), the control unit 51 starts searching by the catalog search unit 511 (step S15).

In particular, the catalog search unit 511 reads out the data for nail catalog stored in the catalog search data unit of the ROM 52 and searches whether the items selected by a user in the search setting screen 132 are included in the items stored for each nail design as data for nail catalog. When each of the selected items is included, +1 point is added, and 36 nail designs are extracted in a descending order from the design to which most points are added.

The search result by the catalog search unit 511 is displayed in the display unit 13 as the search result screen 133 (see FIG. 18) (step S16). As shown in FIG. 18, in the embodiment, the nail designs which are extracted by the catalog search unit 511 are displayed in the search result screen 133 in units of eighteen. By a user touching the preferred nail designs in the search result screen 133, the nail designs can be selected. Further, when all of the nail designs cannot be displayed in one display screen, the screen can be scrolled by operating the next row button 156 or the previous row button 167. The control unit 51 determines whether the return button 153 is operated in the search result screen 133 (step S17). When it is determined that the return button 153 is operated (step S17; YES), the control unit 51 returns to step S11 and makes the display unit 13 display the search setting screen 132. On the other hand, when it is determined that the return button 153 is not operated (step S17; NO), the control unit 51 determines whether one or more nail designs are selected in the search result screen 133 (step S18). When it is determined that one or more nail designs are selected (step S18; YES), the control unit 51 further determines whether two or more nail designs are selected in the search result screen 133 (step S19). When it is determined that two or more nail designs are not selected (step S19; NO), the control unit 51 determines whether the OK button 155 is operated in the search result screen 133 (step S20). When it is determined that the OK button 155 is not operated (step S20; NO) and when it is determined that none of the nail designs are selected (step S18; NO), the control unit 51 returns to step S16 and repeats the processing. Further, when it is determined that one nail design is selected and the OK button 155 is operated (step S20; YES), the one nail design is selected as the nail design to be printed on the nail portions. As shown in step S27 of FIG. 11, the design confirmation screen 135 which indicates an image when the nail design is printed on the five fingers, from the thumb to the little finger, (see FIG. 20) is displayed in the display unit 13.

Moreover, when it is determined that two or more nail designs are selected (step S19; YES), the control unit 51 displays the narrow down button 155 in the search result screen 133 and hides the OK button 158 (step S21). In such case, the control unit 51 determines whether the narrow down button 155 is operated in the design confirmation screen 135 (step S22) as shown in FIG. 11. When it is determined that the narrow down button 155 is not operated (step S22; NO), the control unit 51 returns to step S16 and repeats the processing. On the other hand, when it is determined that the narrow down button 155 is operated (step S22; YES), the control unit 51 makes the display unit 13 display the design selection screen 134 (see FIG. 19) (step S23). Only the nail designs selected by a user in the search result screen are displayed in the design selection screen 134, and by a user touching the preferred nail design among the nail designs, one nail design can be selected. The selected nail design is to be highlighted in the display screen. As shown in FIG. 19, in the embodiment, a case where four nail designs which are design No. 0004, design No. 1000, design No. 0070 and design No. 0002 are displayed in the design selection screen 134 as a result of narrowing down and a user selected the nail design of design No. 0070 among the four designs is shows as an example.

When the design selection screen 134 is displayed in the display unit 13, the control unit 51 determines whether the return button 153 is operated in the design selection screen 134 (step S24). When it is determined that the return button 153 is operated (step S24; YES), the control unit 51 returns to step S16 and makes the display unit 13 display the search result screen 133. On the other hand, when it is determined that the return button 153 is not operated (step S24; NO), the control unit 51 determines whether one nail design is selected in the design selection screen 134 (step S25). When it is determined that none of he nail designs is selected (step S25; NO), the control unit 51 returns to step S23 and repeats the processing. When it is determined that one nail design is selected (step S25; YES), the control unit 51 determines whether the OK button 158 is operated (step S26). When it is determined that the OK button 158 is not operated (step S26; NO), the control unit 51 returns to step S23 and repeats the processing. On the other hand, when it is determined that the OK button 158 is operated (step S26; YES), the nail design is selected as the nail design to be printed on the nail portions and the design confirmation screen 135 (see FIG. 20) is displayed in the display unit 13 (step S27).

As shown in FIG. 20, an image of when the nail design is printed on five fingers, from the thumb to the little finger, is displayed in the design confirmation screen 135. When the design confirmation screen 135 is displayed, the control unit 51 determines whether the confirmation OK button 159 is operated (step S28). When it is determined that the confirmation OK button 159 is operated (step S28; YES), the nail design is decided as the design to be printed on the nail portions of a user and the processing ends. On the other hand, when it is determined that the confirmation OK button 159 is not operated (step S28; NO), the control unit 51 returns to step S27 and repeats the processing. Here, when the return button 153 is operated in the design confirmation screen 135, the control unit 51 makes the display unit 13 display the design selection screen 134 which is the previous screen and repeats the processing thereafter.

Next, FIGS. 12 to 14 show a flowchart of when the nail design to be displayed in the display unit 13 is selected in nail concierge mode and the nail design display processing is to be performed (that is, step S5 in FIG. 9).

When the nail concierge mode button 152 is operated in the mode selection screen 131 and the nail concierge mode is selected, the first item setting screen 136 (see FIG. 21) is displayed in the display unit 13 (step S31). As shown in FIG. 21, a plurality of items such as “shirt/blouse” and “dress” which broadly categorize types of various outfits are displayed as “fashion items” in the first item setting screen 136, and by a user touching the display screen, a type of output which a user plans to wear on the occasion of having her nails done can be specified (set). The selected items are to be highlighted and the selection can be canceled by pressing the item twice. Further, the control unit 51 determines whether the return button 161 is operated in the first item setting screen 136 (step S32). When it is determined that the return button 161 is operated (step S32; YES), the control unit 51 makes the display unit 13 display the previous screen, that is, the mode selection screen 131 (see FIG. 16) (step S33) and repeats the processing shown in FIG. 9.

On the other hand, when it is determined that the return button 161 is not operated (step S32; NO), the control unit 51 further determines whether the OK/next button 162 is operated (step S34). When it is determined that the OK/next button 162 is not operated (step S34; NO), the control unit 51 returns to step S31 and repeats the processing. On the other hand, when it is determined that the OK/next button 162 is operated (step S34; YES), the control unit 51 sets the number of fashion items selected (set) by a user in the first item setting screen 136 as N and stores the value of N in the RAM 53. In the embodiment, the item “fashion item” selected by a user is “dress” only, and therefore, the number of fashion item “N” is 1 and “N=1” is stored in the RAM 53.

Next, the control unit 51 (the display control unit 515) makes the display unit 13 display the second item setting screen 137 (see FIG. 22) (step S36). As shown in FIG. 22, a plurality of items that categorize various types of outfits more in detail, such as “chiffon”, “long sleeve” and “formal dress” are displayed as types of “fashion items” in the second item setting screen 137, and by a user touching the display screen, more specific type of the outfit the user plans to wear on the occasion for having her nails done can be specified (set). The selected items are to be highlighted and can be canceled by pressing the item twice. Further, the control unit 51 determines whether the return button 161 is operated in the second item setting screen 137 (step S37). When it is determined that the return button 161 is operated (step S37; YES), the control unit 51 returns to step S31 and makes the display unit 13 display the first item setting screen 136 (see FIG. 21), and repeats the processing.

When it is determined that the return button 161 is not operated (step S37; NO), the control unit 51 further determines whether the OK/next button 162 is operated (step S38). When it is determined that the OK/next button 162 is not operated (step S38; NO), the control unit 51 returns to step S31 and repeats the processing.

On the other hand, when it is determined that the OK/next button 162 is operated (step S38; YES), the control unit 51 (the display control unit 515) makes the display unit 13 display the third item setting screen 138 (see FIG. 23) (step S39). As shown in FIG. 23, a plurality of items indicating patterns of various types of outfits such as “plain”, “border print” and “flower” are displayed as patterns of “fashion items” in the third item setting screen 138, and by a user touching the display screen, specific patterns of the outfit a user plans to wear on the occasion for having her nails done can be specified (set). The selected items are to be highlighted and the selection can be canceled by pressing the item twice. The control unit 51 determines whether the return button 161 is operated in the third item setting screen 138 (step S40). When it is determined that the return button 161 is operated (step S40; YES), the control unit 51 returns to step S36 and makes the display unit 13 display the second item setting screen 137 (see FIG. 22) and repeats the processing.

When it is determined that the return button 161 is not operated (step S40; NO), the control unit 51 further determines whether the OK/next button 162 is operated (step S41). When it is determined that the OK/next button 162 is not operated (step S41; NO), the control unit 51 returns to step S39 and repeats the processing.

On the other hand, when it is determined that the OK/next button 162 is operated (step S41; YES), the control unit 51 (the display control unit 515) makes the display unit 13 display the fourth item setting screen 139 (see FIG. 24) (step S42). As shown in FIG. 24, 40 colors for each of the items “overall color”, “base color” and “pattern color” are displayed as colors of “fashion items” in the fourth item setting screen 139, and by a user touching the display screen, color of the outfit which a user plans to wear on the occasion for having her nails done can be specified (set). The selected items are to be highlighted and the selection can be canceled by pressing the item twice. The control unit 51 determines whether the return button 161 is operated in the fourth item setting screen 139 (step S43). When it is determined that the return button 161 is operated (step S43; YES), the control unit 51 returns to step S39 and makes the display unit 13 display the third item setting screen 138 (see FIG. 23), and repeats the processing.

When it is determined that the return button 161 is not operated (step S43; NO), the control unit 51 further determines whether the OK/next button 162 is operated (step S44). When it is determined that the OK/next button 162 is not operated (step S44; NO), the control unit 51 returns to step S42 and repeats the processing.

On the other hand, when it is determined that the OK/next button 162 is operated (step S44; YES), the control unit 51 sets the number “N” of fashion items specified by a user to “N−1” and sets the value of “N−1” as new value of “N” (step S45). Then, the control unit 51 determines whether this new value of “N” is “0” (step S46).

When it is determined that the new value of “N” is not “0” (step S46; NO), the control unit 51 returns to step S36 and makes a user similarly specify (set) the details, colors and patterns for the fashion items of which color, pattern and the like are not yet specified (set) by subsequently displaying the screens of the second item setting screen 137 (see FIG. 22) to the four item setting screen 139 (see FIG. 24). For example, when the fashion items selected by a user are “shirt/blouse” and “skirt”, the screens of the second item setting screen 137 (see FIG. 22) to the fourth item setting screen 139 (see FIG. 24) are sequentially displayed for “shirt/blouse” first to specify (set) the details, colors and patterns of “shirt/blouse”. Next, the screen of the second item setting screen 137 (see FIG. 22) to the fourth item setting screen 139 (see FIG. 24) are sequentially displayed for “skirt” to similarly specify (set) the details, colors and patterns of “skirt”.

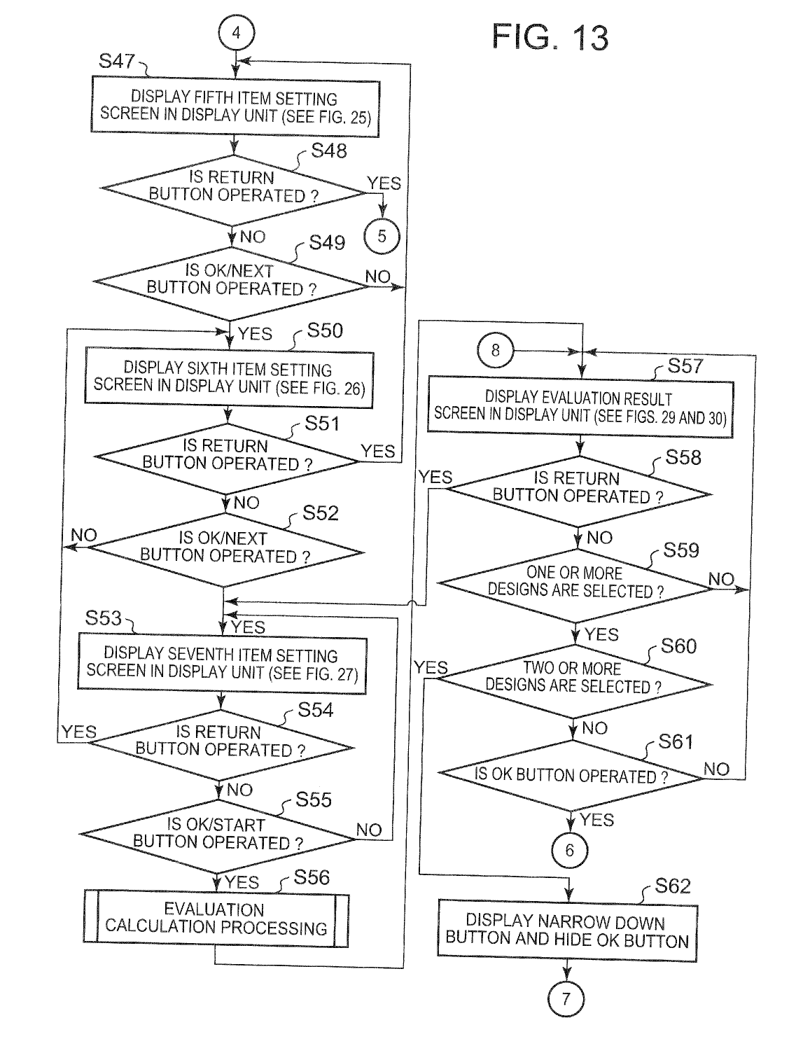

When it is determined that the new value of “N” is “0” (step S46; YES), the control unit 51 (the display control unit 515) makes the display unit 13 display the fifth item setting screen 140 (see FIG. 25) as shown in FIG. 13 (step S47). In the embodiment, because the only fashion item selected by a user is “dress”, the value of N−0 is to be 0 (N=0) and the fifth item setting screen 140 (see FIG. 25) is to be displayed in the display unit 13.

As shown in FIG. 25, six types of “shoes type”, 40 colors of “shoes color”, 5 types of “bag type” and 40 colors of “bag color” are displayed as items that can be selected in the fifth item setting screen 140, and by a user touching the display screen, type and colors of the shoes that a user plans to wear and type and colors of the bag a user plans to use on the occasion for having her nails done can be specified (set). The selected items are to be highlighted and the selection can be canceled by pressing the item twice. The control unit 51 determines whether the return button 161 is operated in the fifth item setting screen 140 (step S48). When it is determined that the return button 161 is operated (step S48; YES), the control unit 51 returns to step S42 and makes the display unit 13 display the fourth item setting screen 139 (see FIG. 24), and repeats the processing.

When it is determined that the return button 161 is not operated (step S48; NO), the control unit 51 further determines whether the OK/next button 162 is operated (step S49). When it is determined that the OK/next button 162 is not operated (step S49; NO), the control unit 51 returns to step S47 and repeats the processing.

On the other hand, when it is determined that the OK/next button 162 is operated (step S49; YES), the control unit 51 (the display control unit 515) makes the display unit 13 display the sixth item setting screen 141 (see FIG. 26) (step S50). As shown in FIG. 26, items such as “feminine”, “sporty”, “elegant” and “modern” are displayed as “overall type/image” in the sixth item setting screen 141, and as a user touching the display screen, overall type/image of a user prepared for the occasion she plans to have her nails done can be specified (set). The selected items are to be highlighted and the selection can be canceled by pressing the item twice. The control unit 51 determines whether the return button 161 is operated in the sixth item setting screen 141 (step S51). When it is determined that the return button 161 is operated (step S51; YES), the control unit 51 returns to step S47 and makes the display unit 13 display the fifth item setting screen 140 (see FIG. 25), and repeats the processing.

When it is determined that the return button 161 is not operated (step S51; NO), the control unit 51 further determines whether the OK/next button 162 is operated (step S52). When it is determined that the OK/next button 162 is not operated (step S52; NO), the control unit 51 returns to step S50 and repeats the processing.

On the other hand, when it is determined that the Ok/next button 162 is operated (step S52; YES), the control unit 51 (the display control unit 515) makes the display unit 13 display the seventh item setting screen 142 (see FIG. 27) (step S53). As shown in FIG. 27, items such as appearance age of a user (age of the target who plans to have nails done), scene of the occasion for having nails done (situation and the like of the occasion), season, a person who a user plans to meet (who to meet) are displayed in the seventh item setting screen 142, and by a user touching the display screen, user's age, scene of the occasion for having her nails done, who to meet at the occasion and the like can be specified (set). The selected items are to be highlighted and the selection can be canceled by pressing the item twice. The control unit 51 determines whether the return button 161 is operated in the sixth item setting screen 141 (step S54). When it is determined that the return button 161 is operated (step S54; YES), the control unit 51 returns to step S50 and makes the display unit 13 display the sixth item setting screen 141 (see FIG. 26), and repeats the processing.

When it is determined that the return button 161 is not operated (step S54; NO), the control unit 51 further determines whether the OK/next button 162 is operated (step S55). When it is determined that the OK/next button 162 is not operated (step S55; NO), the control unit 51 returns to step S53 and repeats the processing.

On the other hand, when it is determined that the OK/next button 162 is operated (step S55; YES), the control unit 51 (the evaluation calculation 512) performs evaluation calculation processing (step S56).

Here, specific content of the evaluation calculation processing performed by the control unit 51 (the evaluation calculation unit 512) will be described with reference to FIG. 15.

In the evaluation calculation processing, the evaluation calculation unit 512 first sets 0 as the evaluation score S of the first nail design (step S71). Further, the evaluation calculation unit 512 reads out the number “N” of fashion items selected by a user (step S72) and sets the Nth fashion item as the target for evaluation calculation (step S73). For example, when the number N of fashion items is 3, the third fashion item is to be set as the target for evaluation calculation. In the embodiment, because the only fashion item selected by a user is “dress”, the number N of fashion items is 1 (N=1) and “dress” is set as the Nth fashion item.

The evaluation calculation unit 512 determines whether the set fashion item is any of “dress”, “suit”, “coat” and “Japanese traditional kimono” (step S74). When it is determined that the fashion item is one of the above (step S74; YES), the evaluation calculation unit 512 further determines whether the set fashion item is any one of “half coat”, “haori coat (coat for kimono)” and “obi (sash for kimono)” (step S75). When it is determined that the fashion item is not any of the above (step S75; NO), “1” is set for the weighting coefficient Kin the evaluation calculation processing for the fashion item (step S76). On the other hand, when it is determined that the fashion item is not any one of “dress”, “suit”, “coat” and “kimono” (step S74; NO) and the fashion item is one of “half coat”, “haori coat” and “obi” (step S75; YES), “½” is set for the weighting coefficient K in the evaluation calculation processing for the fashion item (step S77).

With respect to “S” which is evaluation score of a nail design, evaluation score for the selected outfit type is calculated first, and then, this calculation result is set for new “S” (step S78). For example, because the selected fashion item is “dress” in the embodiment, the weighting coefficient is 1 and the original evaluation score “S” is “0”. Therefore, S=1×sum of evaluation scores of selected outfit types it to be calculated.

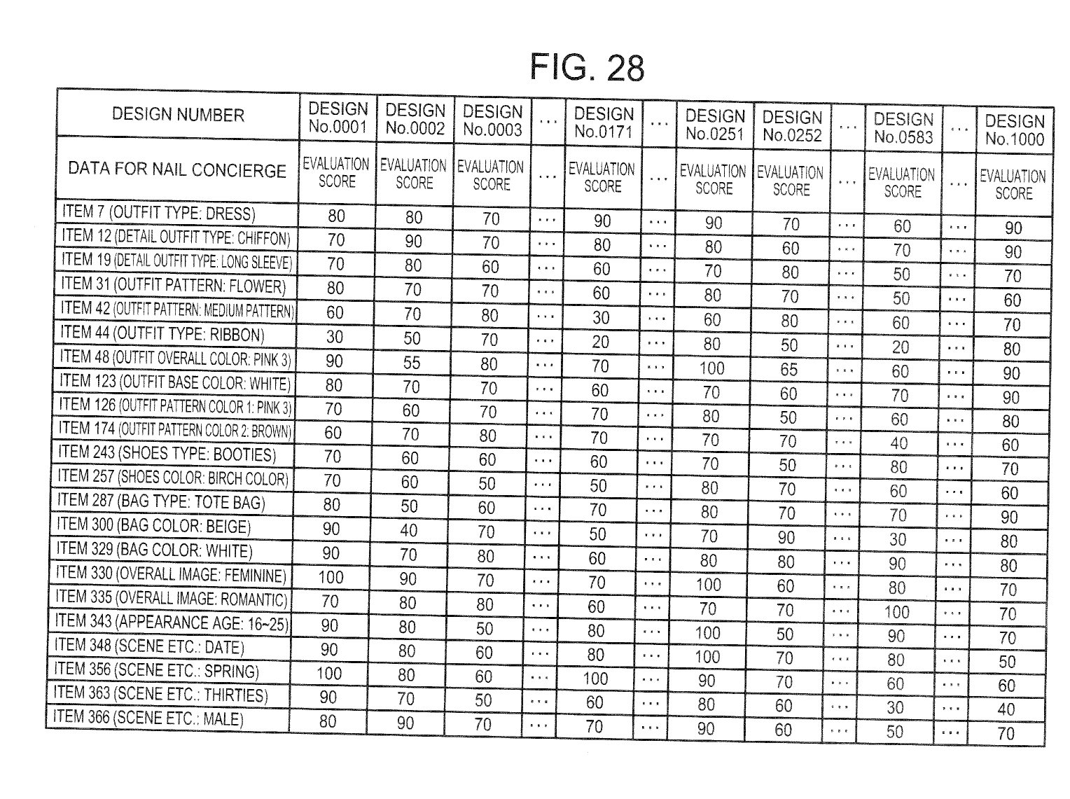

FIG. 28 only shows evaluation scores of the items selected by a user in the embodiment for each nail design extracted from the data in the evaluation data unit 52a of the ROM 52 shown in FIG. 7 for convenience. As shown in FIG. 28 and FIG. 7, in the embodiment, evaluation point of design No. 0001 with respect to “dress” which is the type of outfit is 80 points and with respect to “chiffon” and “long sleeve” which are details of the outfit selected by a user is 70 points each, for example. Therefore, the sum of evaluation scores of the outfit type is 220 points. Thus, the evaluation score of the outfit type is 1×220, and the new value of “S” which is the calculation result is to be 220.

Next, the evaluation calculation unit 512 calculates the sum of evaluation scores of the selected outfit patterns and adds the calculated scores to the new value of “S” calculated in step S78, and then, sets this calculated result as the new value of “S” (stet S79). For example, in the embodiment, “flower”, “medium size pattern” and “ribbon” are selected as patterns of the outfit, and evaluation scores of design No. 0001 with respect to the patterns of the outfit are as follow: 80 points for “flower”, 60 points for “medium side pattern” and 30 points for “ribbon” (see FIG. 28). Therefore, the new value for “S” which can be obtained by adding the sum of evaluation scores for the patterns of the outfit to the evaluation score of the type of outfit is 220+1×170, and the new value of “S” which is the calculation result is to be 390.

Next, the evaluation calculation unit 512 calculates the sum of evaluation scores of overall colors of the selected outfit and adds this calculated score to the new value of “S” calculated in step S79, and then, sets the calculated result as new value of “S” (step S80). Here, because the overall color of the outfit is an evaluation element that plays great roll in determining the match between the nail design and the outfit, weighting which is double is added to the sum of evaluation scores of overall colors of the outfit in the embodiment. In the embodiment, “pink 3” is selected as the overall color of the outfit, and the evaluation score of design No. 0001 with respect to the overall color of outfit “pink 3” is 90 points, for example (see FIG. 28). Therefore, the new value of “S” which can be obtained by adding the sum of evaluation scores of overall colors of the outfit to the evaluation score so far is 390+2×1×90, and the new value of “S” which is the calculation result is to be 570.

Next, the evaluation calculation unit 512 calculates the sum of evaluation scores for base colors of the selected outfit and adds the calculated score to the new value of “S” which is calculated in step S80, and then, sets the calculation result as new value of “S” (step S81). Here, because the base color of the outfit plans relatively minor roll in determining match between the nail design and the output, the sum of evaluation scores for base colors of the outfit will be weighted by half to be added. In the embodiment, “white” is selected as the base color of the outfit, and the evaluation score of design No. 0001 with respect to the base color of outfit “white” is 80 point, for example (see FIG. 28). Therefore, the new value of “S” which can be obtained by adding the sum of evaluation scores for base colors of the outfit to the evaluation score so far is 570+1/2×1×80, and the new value of “S” which is the calculation result is to be 610.

Next, the evaluation calculation unit 512 calculates the sum of evaluation scores for pattern colors 1 of the selected outfit and adds the calculated score to the new value of “S” which is calculated in step S81, and then, sets the calculate result as new value of “S” (step S82). Here, because the pattern color 1 of the outfit plays a minor roll in determining match between the nail design and the outfit, the sum of evaluation scores for pattern colors 1 of the outfit is weighted by ¼ to be added in the embodiment. In the embodiment, “pink 3” is selected as the pattern color 1 of the outfit and the evaluation score of design No. 0001 with respect to the pattern color 1 “pink 3” of the outfit is 70 points, for example (see FIG. 28). Therefore, the new value of “S” which can be obtained by adding the sum of evaluation scores of pattern colors 1 of the outfit to the evaluation score so far is 610+1/4×1×70, and the new value of “S” which is the calculation result is to be 627.5.

Similarly, the evaluation calculation unit 512 calculates the sum of evaluation scores for pattern colors 2 of the selected outfit and adds the calculated score to the new value of “S” which is calculated in step S82, and then, sets the calculated result as new value of “S” (step S83). Here, because pattern colors 2 of the outfit plays a minor roll in determining match between the nail design and the outfit, the sum of evaluation scores for pattern colors 2 of the outfit is weighted by ¼ to be added in the embodiment. In the embodiment, “brown” is selected as the pattern color 2 of the outfit, and the evaluation score of design No. 0001 with respect to the pattern color 2 “brown” of the outfit is 60 points, for example (see FIG. 28). Therefore, the new value of “S” which is obtained by adding the sum of evaluation scores for pattern colors 2 of the output to the evaluation score so far is 627.5+1/4×1×60, and new value of “S” which is the calculation result is to be 642.5.

Similarly, the evaluation calculation unit 512 calculates the sum of evaluation scores for pattern colors 3 of the selected outfit and adds the calculated score to the new value of “S” which is calculated in step S83, and then, sets the calculated result as new value of “S” (step S84). Here, because pattern colors 3 of the outfit play minor roll in determining match between the nail design and the outfit, the sum of evaluation scores for pattern colors 3 of the outfit is weighted by ¼ to be added in the embodiment. In the embodiment, because pattern color 3 of the outfit is not specified, there is no score to be added and “S” remains 642.5.

Next, the evaluation calculation unit 512 sets the number “N” of the fashion items specified by a user to “N−1” and sets this value as new value of “N” (step S85). Then, the evaluation calculation unit 512 determines whether this new value of “N” is “0” (step S86).

When it is determined that the new value of “N” is not “0” (step S86; NO), the process return to step S73 and similar calculation processing of evaluation score is to be performed for the fashion items in which calculation of evaluation score is not yet performed for colors, patterns and the like.

On the other hand, when it is determined that the new value of “N” is “0” (step S86; YES), the evaluation calculation unit 512 calculates the sum of evaluation scores for shoes type which is selected and adds the calculated score to the new value of “S” which is calculated in step S84, and then, sets the calculated result as new value of “S” (step S87). Here, because shoes type plays a minor roll in determining match between the nail design and the outfit, the sum of evaluation scores for shoes type is weighted by ¼ to be added in the embodiment. In the embodiment, “booties” is selected as shoes type, and the evaluation score of design No. 0001 with respect to the shoes type “booties” is 70 point, for example (see FIG. 28). Therefore, the new value of “S” which can be obtained by adding the sum of evaluation scores of shoes types to the evaluation point so far is 642.5+1/4×1×70, and the new value of “S” which is the calculation result is to be 660.

Next, the evaluation calculation unit 512 calculates the sum of evaluation scores for colors of the selected shoes and adds this point to the new value of “S” which is calculated in step S87, and then, sets the calculation result as new value of “S” (step S88). Here, because colors of the shoes play a minor roll in determining match between the nail design and the outfit, the sum of evaluation scores for colors of the shoes is weighted by ¼ to be added in the embodiment. In the embodiment, “birch color” is selected as color of the shoes, and the evaluation score of design No. 0001 with respect to the shoes color “birch color” is 70 point, for example (see FIG. 28). Therefore, the new value of “S” which can be obtained by adding the sum of evaluation scores for colors of the shoes to the evaluation score so far is 660+1/4×1×70, and the new value of “S” which is the calculation result is to be 677.5.

Next, the evaluation calculation unit 512 calculates the sum of evaluation scores for type of the selected bag and adds this score to the new value of “S” which is calculated in step S88, and then, sets the calculation result as new value of “S” (step S89). Here, because type of bag plays relatively minor roll in determining match between the nail design and the output, the sum of evaluation scores for type of bag will be weighted by half to be added. In the embodiment, “tote bag” is selected as the type of bag, and the evaluation score of design No. 0001 with respect to the bag type “tote bag” is 80 point, for example (see FIG. 28). Therefore, the new value of “S” which can be obtained by adding the sum of evaluation scores for type of bag to the evaluation score so far is 677.5+1/2×1×80, and the new value of “S” which is the calculation result is to be 717.5.

Next, the evaluation calculation unit 512 calculates the sum of evaluation scores for colors of the selected bag and adds this score to the new value of “S” which is calculated in step S89, and then, sets the calculation result as new value of “S” (step S90). Here, because colors of bag play relatively minor roll in determining match between the nail design and the outfit, the sum of evaluation scores for colors of the bag will be weighted by half to be added in the embodiment. In the embodiment, “beige” and “white” are selected as colors of the bag, and the evaluation score of design No. 0001 with respect to the color of bag “beige” is 90 point and with respect to the color of bag “white” is 90 point, for example (see FIG. 28). Therefore, new value of “S” which can be obtained by adding the sum of evaluation scores for colors of bag to the evaluation point so far is 717.5+1/2×1×180, and the new value of “S” which is the calculation result is to be 807.5.

Next, the evaluation calculation unit 512 calculates the sum of evaluation scores for the selected type/image and adds this score to the new value of “S” which is calculated in step S90, and then, sets the calculation result as new value of “S” (step S91). In the embodiment, “feminine” and “romantic” are selected as the type/image, and the evaluation score of design No. 0001 with respect to the type/image “feminine” is 100 point and with respect to the type/image “romantic” is 70 point, for example (see FIG. 28). Therefore, the new value of “S” which can be obtained by adding the sum of evaluation scores for type/image to the evaluation score so far is 807.5+170, and the new value of “S” which is the calculation result is to be 977.5.

Next, the evaluation calculation unit 512 calculates the sum of evaluation scores for the selected appearance age, scene and who to meet and adds this score to the new value of “S” which is calculated in step S91, and then, sets the calculation result as new value of “S” (step S92). In the embodiment, “16 to 25” is selected for appearance age, “date”, “spring”, “thirties” and “male” are selected for the scene and who to meet, and the evaluation score of design No. 0001 with respect to the appearance age “16 to 25” is 90 point, with respect to “date” is 90 point, with respect to “spring” is 100 point, with respect to “thirties” is 90 point and with respect to “male” is 80 point, for example (see FIG. 28). Therefore, new value of “S” which can be obtained by adding the sum of evaluation scores for appearance age, scene and who to meet to the evaluation score so far is 977.5+450, and the new value of “S” which is the calculation result is to be 1427.5.

The evaluation calculation unit 512 similarly performs calculation processing to all of the nail designs and sequentially stores the calculation results in the evaluation result data unit 53a of the RAM 53.

When evaluation result which is the total evaluation score is calculated for each nail design by the evaluation calculation unit 512, the rank determination unit 513 compares evaluation results of other nail design which are already stored in the evaluation result data unit 53a to the newly obtained evaluation results, and decides a tentative ranking in a descending order starting from the nail design having the highest score. At this time, evaluation results of nail designs which are lower in the ranking than a certain rank may be deleted from the evaluation result data unit 53a.

Going back to FIG. 13, when calculation of evaluation result and determination of ranking are finished for all of the nail designs, the control unit 51 (the display control unit 515) makes the display unit 13 display the evaluation result screen 143 (see FIGS. 29 and 30) (step S57).

As shown in FIGS. 29 and 30, in the embodiment, nail designs which are ranked high by the ranking determination unit 513 are displayed in the evaluation result screen 143 in units of six, each nail design being displayed with the ranking, design number and comment. A user can select nail designs by touching the preferred nail design in the evaluation result screen 143. Further, when the nail designs cannot be displayed in on display screen, the screen can be scrolled by operating the next row button 165 and the previous row button 166. The control unit 51 determines whether the return button 161 is operated in the evaluation result screen 143 (step S58). When it is determined that the return button 161 is operated (step S58; YES), the control unit 51 returns to step S53 and makes the display unit 13 display the seventh item setting screen 142 which is the previous display screen.

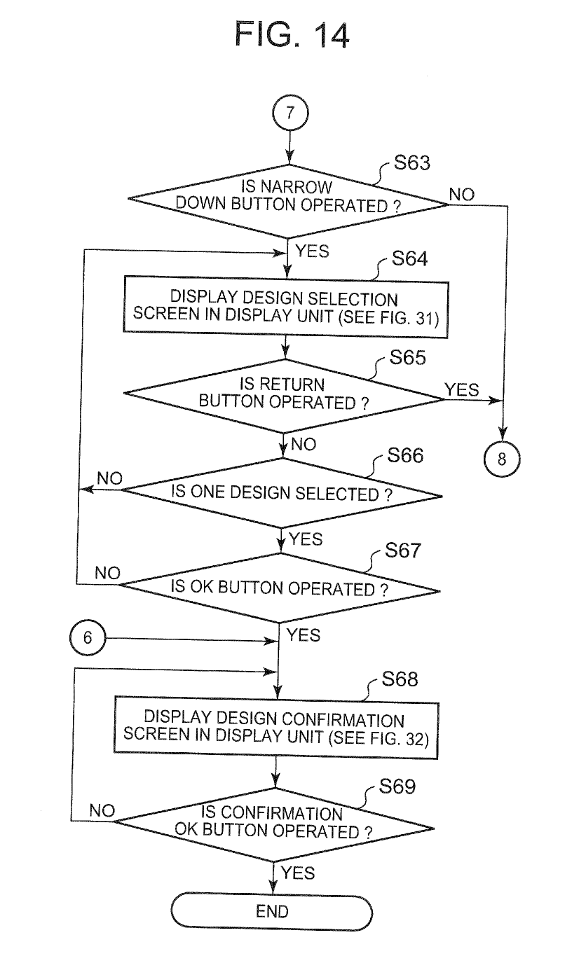

On the other hand, when it is determined that the return button 161 is not operated (step S58; NO), the control unit 51 determines whether one or more nail designs are selected in the evaluation result screen 143 (step S59). When it is determined that one or more nail designs are selected (step S59; YES), the control unit 51 further determines whether two or more nail designs are selected in the evaluation result screen 143 (step S60). When it is determined that two or more nail designs are not selected (step S60; NO), the control unit 51 determines whether the OK button 167 is operated in the evaluation result screen 143 (step S61). When it is determined that the OK button 167 is not operated (step S61; NO) or when it is determined that none of the nail designs are selected (step S59; NO), the control unit 51 returns to step S57 and repeats the processing. Further, when it is determines that one nail design is selected and the OK button 167 is operated (step S61; YES), the one nail design is selected as the nail design to be printed on the nail portions, and as shown in step S68 of FIG. 14, the design confirmation screen 145 indicating an image when the nail design is printed on the five fingers, from the thumb to little finger, (see FIG. 32) is displayed in the display unit 13.

Moreover, when it is determined that two or more nail designs are selected (step S60; YES), the narrow down button 164 is displayed and the OK button 167 is hidden in the evaluation result screen 143 (step S62). In such case, as shown in FIG. 14, the control unit 51 determines whether the narrow down button 164 is operated in the evaluation result screen 143 (step S63). When it is determined that the narrow down button 164 is not operated (step S63; NO), the control unit 51 returns to step S57 and repeats the processing. On the other hand, when it is determined that the narrow down button 164 is operated (step S63; YES), the control unit 51 makes the display unit 13 display the design selection screen 144 (see FIG. 31) (step S64). Only the nail designs which a user selected in the evaluation result screen 143 are displayed in the design selection screen 144, and a user can select a nail design by touching the preferred nail design among the displayed nail designs. The selected nail design is to be highlighted in the display screen. As shown in FIG. 31, in the embodiment, a case where four nail designs which are design No. 0251, design No. 0001, design No. 0003 and design No. 0171 are displayed in the design selection screen 144 as a result of narrowing down and the nail design of design No. 0001 is selected by a user among the above designs is shown as an example.

When the design selection screen 144 is displayed in the display unit 13, the control unit 51 determines whether the return button 161 is operated in the design selection screen 144 (step S65). When it is determined that the return button 161 is operated (step S65; YES), the control unit 51 returns to step S57 and makes the evaluation result screen 143 in the display unit 13. On the other hand, when it is determined that the return button 161 is not operated (step S65; NO), the control unit 51 determines whether one nail design is selected in the design selection screen 144 (step S66). When it is determines that none of the nail designs are selected (step S66; NO), the control unit 51 returns to step S64 and repeats the processing. On the other hand, when it is determined that one nail design is selected (step S66; YES), the control unit 51 determines whether the OK button 167 is operated (step S67). When it is determined that the OK button 167 is not operated (step S68; NO), the control unit 51 returns to step S64 and repeats the processing. On the other hand, when it is determined that the OK button 167 is operated (step S67; YES), the one nail design is selected as the nail design to be printed on the nail portions and the design confirmation screen 145 (see FIG. 32) is displayed in the display unit 13 (step S68).

As shown in FIG. 32, an image where the nail design is printed on five fingers, from the thumb to little finger is to be displayed in the design confirmation screen 145. When the design confirmation screen 145 is displayed, the control unit 51 determines whether the confirmation OK button 168 is operated (step S69). When it is determined that the confirmation OK button 168 is operated (step S69; YES), the nail design is decided as the design to be printed on the nail portions of a user and the processing ends. On the other hand, when it is determined that the confirmation OK button 168 is not operated (step S69; NO), the control unit 51 returns to step S68 and repeats the processing. Here, when the return button 161 is operated in the design confirmation screen 145, the design selection screen 144 which is the previous screen is displayed in the display unit 13 and the processing thereafter is repeated.

As described above, the following advantages can be obtained according to the nail print apparatus 1 of the embodiment.

In the embodiment, as nail design selection modes, the nail print apparatus 1 is provided with the nail concierge mode which extracts the nail designs that matches with the specified fashion related items among a plurality of nail designs just by specifying arbitrary fashion related items regarding the type, color, pattern, type and color of shoes and bag, appearance age of a user herself, situation and season of the occasion, age and gender of a person who a user plans to meet and the like among a plurality of fashion related items displayed in the display unit 13. In the nail concierge mode, the extracted nail designs can be displayed in the display unit 13 in a descending order from the design having highest ranking for matching level. Therefore, even when a user cannot determine which nail design matches with her fashion such as outfit and the like she plans to wear on the occasion, candidate nail designs can be suggested to a user and a user can easily, promptly and accurately confirm the nail designs suited for her outfit and the like in the display unit 13. Thereby, anyone can easily enjoy coordination of a nail design that matches with her outfit and the like.

Moreover, when many nail designs are stored, a user tend to chose similar design every time when a user herself makes the selection. However, by using the nail concierge mode of the embodiment, a user can enjoy trying various nail designs because the nail concierge mode can objectively determine the match between all of the nail designs and a user's outfit and the like by taking various items and elements into consideration and can suggest the nail designs suited for a user's outfit and the like. Thus, a user can continue to use the nail print apparatus 1 without being tired of using the apparatus.

Further, in the nail concierge mode of the embodiment, matching level between each nail design and each of the fashion related items is stored as an evaluation score (evaluated value). Therefore, data amount can be small even when data for may items is to be stored so that matching levels with each nail design can be evaluated more in detail. In such way, matching level between each nail design and the outfit and the like can be evaluated accurately in detail by taking many elements into consideration.

Moreover, in the embodiment, there are two nail design selection modes for selecting nail designs to make suggestions to a user by displaying nail designs in the display unit, which are the nail catalog mode and the nail concierge mode. Therefore, a user can conveniently use the modes according to her feeling and needs of the day. Therefore, a user can enjoy using the nail print apparatus 1 without being tired of using the apparatus.

In the nail concierge mode, at least a plurality of fashion items (that are, outfit types) and a plurality of fashion item related items including color of each of the fashion items are included in the fashion related items which are taken into consideration when selecting nail designs. Therefore, nail designs can be selected by taking matching level between nail designs and outfits and such like that plays the largest roll in total coordination including nails into consideration. Thus, a user can easily enjoy coordination of outfits and nail design.

Comment data corresponding to each nail design is stored in the ROM 52, and the comments are displayed along with nail designs corresponding respectively to the nail design when nail designs that match with the outfit and such like are to be suggested to a user by being displayed in the display unit 13. Therefore, a user can easily acknowledge the image of each nail design and can decide the nail design to be printed on her fingers more appropriately.

The embodiment of the present invention is described above. However, the present invention is not limited to the above embodiment and it is needles to say that various modifications can be carried out within the scope of the invention.

For example, in the embodiment, the case where two nail design selection modes, which are nail catalog mode and nail concierge mode, are provided as nail design selection modes for selecting nail designs to make suggestions to a user by displaying the nail designs in the display unit. However, only nail concierge mode may be provided as the nail design selection mode.

Moreover, items and elements to be considered in the nail concierge mode are not limited to those suggested in the embodiment, and may be changed arbitrarily. For example, accessories such as necklace and ring can be included as items. Further, “time zone”, occupations such as “sales”, “receptionist”, “apparel related” and the like can be included as items for the category of “scene”.

Moreover, in the embodiment, weighting is carried out so that large score is to be added with respect to outfit type and the like and smaller scores are to be added with respect to shoes and bags. However, the way of weighting is not limited to the way exemplified in the embodiment.

Evaluation result can be calculated by merely adding scores without weighting the scores.

Further, the case where evaluation calculation processing is similarly performed on all of the nail designs when the evaluation calculation unit 512 performs evaluation calculation is described above. However, when the number of nail designs is extremely large, calculations can be performed to a predetermined items by setting thresholds, and the nail design whose scores are at a certain point or smaller can be excluded from evaluation target without further performing calculations of other items.

In the embodiment, the case where score is calculated for each item is described. However, predetermined items can be categorized into groups in advance to be calculated only within each group, for example.

Moreover, with regard to the nail design which are finally selected by a user and the nail designs having good evaluation results, their design numbers or such like may be stored in the RAM 53 or the like. In such case, when a user wishes to print the nail design which has been selected and suggested in the nail concierge mode or such like few days later, printing of the nail design can be carried out easily and promptly without selecting the items again.

Further, for example, items such as a user's age, occupation and the like may be registered in the RAM 53 or the like when they are selected for the first time. In such way, less items should be selected from the next time and selections and suggestions of nail designs can be carried out speedily.

Furthermore, in the embodiment, the case where the first storage circuit is the ROM 52, the second storage circuit is the RAM 53 is described. However, the first and second storage circuits are not limited to the ROM 52 and the RAM 53, respectively, and separate storage units can be provided.

Moreover, in the embodiment, the case where the nail design display control apparatus is the nail print apparatus which includes a print unit and the like and which can print the selected nail design on the nail portions of a user is described. However, nail design display control apparatus which can use the present invention is not limited to nail print apparatus. The present invention can be applied in a display apparatus which does not include a print unit 40 and the like and which makes the display unit 13 display nail designs, for example. Further, nail design selection performed in nail concierge mode exemplified in the embodiment can be applied to a system for searching nail designs, selling nail designs and the like on internet.

Further, in the embodiment, the case where the nail print apparatus which is the nail design display control apparatus is an apparatus for performing printing on nail portions of a user is described. However, the nail print apparatus is not limited to apparatus which performs printing on nail portions. For example, nail design display control apparatus may by an apparatus for printing nail designs on nail chips (artificial nails) and stickers that can be processed into nail chips, and further, may be an apparatus that can perform printing on both nail portion of a user and nail chips.

Other aspects are also not limited to the embodiment and arbitrary modifications can be carried out.

The embodiments disclosed above are examples in all aspects and the invention is not limited to the embodiments shown. Therefore, the scope of the invention is intended to be limited solely by the scope of the claims and not by the above descriptions, and equivalents to the claims within the meaning and range thereof and all the modifications are to be included.

According to a first aspect of the preferred embodiments of the present invention, there is provided a nail design display control apparatus including a first storage circuit which stores a plurality of nail designs, each of which being associated with evaluation values indicating matching levels of a nail design with respect a plurality of related items, an item specifying unit by which a user specifies one or more of related items among a plurality of related items, and an evaluation calculation unit which calculates a sum of the evaluation values with respect to the related items specified by the user for each of the plurality of nail designs.

The nail design display control apparatus further includes a first display control unit which makes a display unit display the plurality of related items, a second storage circuit which stores evaluation results which are calculated by the evaluation calculation unit, a ranking determination unit which performs ranking of each of the nail designs by comparing the evaluation results of the nail designs stored in the second storage circuit to each other, and a second display control unit which makes the display unit display at least one of the nail designs in a descending order from a highest ranking nail design according to the ranking performed by the ranking determination unit.

Preferably, the plurality of related items at least includes a plurality of fashion items indicating fashion related items and a plurality of fashion item related items including colors of the fashion items.

Preferably, the first storage circuit stores comment data which is associated with each of the nail designs and the second display control unit displays the comment data which is associated with each of the nail designs along with a nail design when displaying the nail design in the display unit, the comment data being stored in the first storage circuit.

Preferably, the plurality of related items at least includes any one of a type of outfit, a pattern of outfit, a color of outfit, a type of shoes, a color of shoes, a type of bag, a color of bag, an age of target whose nails are to be done, a situation of occasion, a season, an age range of a person to meet on the occasion and a gender of the person to meet on the occasion.

Preferably, weighting of each of the evaluation values is changed according to a type of a specified related item when the evaluation calculation unit calculates an evaluation result, and calculation processing of the evaluation result of each of the nail designs is performed for all of the nail designs.

Preferably, when an evaluation result of each of the nail designs is calculated by the evaluation calculation unit, the evaluation result being a sum of evaluation scores for each of the nail designs, the ranking determination unit compares a newly obtained evaluation result and evaluation results of nail designs which are already stored in the second storage circuit and determines a provisional ranking in a descending order from a highest ranking nail design.

Preferably, the first storage circuit is a ROM and the second storage circuit is a RAM.

The nail design display control apparatus further includes an insertion unit including an insertion opening where a finger is inserted and a print head which performs printing on a nail of the finger inserted in the insertion unit.

According to a second aspect of the preferred embodiment of the present invention, there is provided a display control method for a nail design display, wherein a first storage circuit stores a plurality of nail designs, each of which being associated with evaluation values indicating matching levels of a nail design with respect to a plurality of related items, and wherein the display control method includes calculating a sum of the evaluation values of the related items specified by a user for each of the plurality of nail designs when one or a plurality of related item is specified by the user among the plurality of related items.

The display control method further including first displaying the plurality of related items in a display unit, storing evaluation results which are calculated in the calculating, ranking of each of the nail designs by comparing the evaluation results of the nail designs calculated in the calculating to each other, and second displaying at least one of the nail designs in the display unit in a descending order from a highest ranking nail design according to the ranking performed in the ranking, and the evaluation results to be compared in the ranking are the evaluation results of the nail designs stored in the storing.

Preferably, the plurality of related items at least include a plurality of fashion items indicating fashion related items and a plurality of fashion item related items including colors of the fashion items.

Preferably, in first storing, comment data which is associated with each of the nail designs is stored, and in second displaying, the comment data which is associated with each of the nail design is displayed along with the nail design when displaying the nail design in the display unit.

Preferably, the plurality of related items at least includes any one of a type of outfit, a pattern of outfit, a color of outfit, a type of shoes, a color of shoes, a type of bag, a color of bag, an age of target whose nails are to be done, a situation of occasion, a season, an age range of a person to meet on the occasion and a gender of the person to meet on the occasion.

Preferably, weighting of each of the evaluation values is changed according to a type of a specified related item when the evaluation calculation unit calculates an evaluation result, and calculation processing of the evaluation result of each of the nail designs is performed for all of the nail designs.

Preferably, when an evaluation result of each of the nail designs is calculated by the evaluation calculation unit, the evaluation result being a sum of evaluation scores for each of the nail designs, a newly obtained evaluation result and evaluation results of nail design which are already stored in the storing are compared and a provisional ranking in a descending order from a highest ranking nail design is determined in the ranking.

Preferably, the first storage circuit is a ROM and the storing is a RAM.

Preferably, the nail design display control apparatus includes an insertion unit including an insertion opening where a finger is inserted and a print head which performs printing on a nail of the finger inserted in the insertion unit.

What is claimed is:

1. A nail design display control apparatus, comprising:
a first storage circuit which stores a plurality of nail designs, each of which being associated with evaluation values indicating matching levels of a nail design with respect a plurality of related items;
an item specifying unit by which a user specifies one or more of related items among a plurality of related items; and
an evaluation calculation unit which calculates a sum of the evaluation values with respect to the related items specified by the user for each of the plurality of nail designs.

2. The nail design display control apparatus according to claim 1, further comprising:
a first display control unit which makes a display unit display the plurality of related items;
a second storage circuit which stores evaluation results which are calculated by the evaluation calculation unit;
a ranking determination unit which performs ranking of each of the nail designs by comparing the evaluation results of the nail designs stored in the second storage circuit to each other; and
a second display control unit which makes the display unit display at least one of the nail designs in a descending order from a highest ranking nail design according to the ranking performed by the ranking determination unit.

3. The nail design display control apparatus according to claim 1, wherein the plurality of related items at least includes a plurality of fashion items indicating fashion related items and a plurality of fashion item related items including colors of the fashion items.

4. The nail design display control apparatus according to claim 2, wherein
the first storage circuit stores comment data which is associated with each of the nail designs; and
the second display control unit displays the comment data which is associated with each of the nail designs along with a nail design when displaying the nail design in the display unit, the comment data being stored in the first storage circuit.

5. The nail design display control apparatus according to claim 1, wherein
the plurality of related items at least includes any one of a type of outfit, a pattern of outfit, a color of outfit, a type of shoes, a color of shoes, a type of bag, a color of bag, an age of target whose nails are to be done, a situation of occasion, a season, an age range of a person to meet on the occasion and a gender of the person to meet on the occasion.

6. The nail design display control apparatus of claim 1, wherein
weighting of each of the evaluation values is changed according to a type of a specified related item when the evaluation calculation unit calculates an evaluation result, and
calculation processing of the evaluation result of each of the nail designs is performed for all of the nail designs.

7. The nail design display control apparatus of claim 1, wherein
when an evaluation result of each of the nail designs is calculated by the evaluation calculation unit, the evaluation result being a sum of evaluation scores for each of the nail designs, the ranking determination unit compares a newly obtained evaluation result and evaluation results of nail designs which are already stored in the second storage circuit and determines a provisional ranking in a descending order from a highest ranking nail design.

8. The nail design display control apparatus according to claim 2, wherein the first storage circuit is a ROM and the second storage circuit is a RAM.

9. The nail design display control apparatus according to claim 1, further comprising:
an insertion unit including an insertion opening where a finger is inserted; and
a print head which performs printing on a nail of the finger inserted in the insertion unit.

10. A display control method for a nail design display,
wherein a first storage circuit stores a plurality of nail designs, each of which being associated with evaluation values indicating matching levels of a nail design with respect to a plurality of related items, and wherein the display control method comprises:
calculating a sum of the evaluation values of the related items specified by a user for each of the plurality of nail designs when one or a plurality of related item is specified by the user among the plurality of related items.

11. The display control method according to claim 10, further comprising:
first displaying the plurality of related items in a display unit;
storing evaluation results which are calculated in the calculating;
ranking of each of the nail designs by comparing the evaluation results of the nail designs calculated in the calculating to each other; and
second displaying at least one of the nail designs in the display unit in a descending order from a highest ranking nail design according to the ranking performed in the ranking, wherein
the evaluation results to be compared in the ranking are the evaluation results of the nail designs stored in the storing.

12. The display control method according to claim 10, wherein the plurality of related items at least include a plurality of fashion items indicating fashion related items and a plurality of fashion item related items including colors of the fashion items.

13. The display control method according to claim 11, wherein
in first storing, comment data which is associated with each of the nail designs is stored; and
in second displaying, the comment data which is associated with each of the nail design is displayed along with the nail design when displaying the nail design in the display unit.

14. The display control method according to claim 10, wherein the plurality of related items at least includes any one of a type of outfit, a pattern of outfit, a color of outfit, a type of shoes, a color of shoes, a type of bag, a color of bag, an age of target whose nails are to be done, a situation of occasion, a season, an age range of a person to meet on the occasion and a gender of the person to meet on the occasion.

15. The display control method according to claim 10, wherein weighting of each of the evaluation values is changed according to a type of a specified related item when the evaluation calculation unit calculates an evaluation result, and
calculation processing of the evaluation result of each of the nail designs is performed for all of the nail designs.

16. The display control method according to claim 10, wherein when an evaluation result of each of the nail designs is calculated by the evaluation calculation unit, the evaluation result being a sum of evaluation scores for each of the nail designs, a newly obtained evaluation result and evaluation results of nail design which are already stored in the storing are compared and a provisional ranking in a descending order from a highest ranking nail design is determined in the ranking.

17. The display control method according to claim 11, wherein the first storage circuit is a ROM and the storing is a RAM.

18. The display control method according to claim 10, wherein the nail design display control apparatus includes:
an insertion unit including an insertion opening where a finger is inserted; and
a print head which performs printing on a nail of the finger inserted in the insertion unit.
